(19) United States
(12) Patent Application Publication
(10) Pub. No.: US 2026/0357111 A1
(43) Pub. Date: Nov. 12, 2026

(54) ADHESIVE SHEET, MULTILAYER SHEET, CHEMICAL LIQUID TANK, AND METHOD FOR PRODUCING CHEMICAL LIQUID TANK

(71) Applicant: SEKISUI CHEMICAL CO., LTD., Osaka (JP)

(72) Inventors: Ryousuke KAWAHARA, Shiga (JP); Akira SHIMOJITOSHO, Shiga (JP); Fumiya SATOU, Osaka (JP); Yudai OGATA, Osaka (JP); Ayane FUKUOKA, Osaka (JP); Nagisa OGATA, Osaka (JP); Takayuki TANIMOTO, Osaka (JP)

(73) Assignee: SEKISUI CHEMICAL CO., LTD., Osaka (JP)

(21) Appl. No.: 19/482,018

(22) PCT Filed: May 9, 2024
(86) PCT No.: PCT/JP2024/017298

§ 371 Date: Nov. 6, 2025

(30) Foreign Application Priority Data
May 11, 2023 (JP) 2023-078815
Jun. 13, 2023 (JP) 2023-096939
Oct. 13, 2023 (JP) 2023-177800

(51) Int. Cl. C09J 7/21; B32B 1/00; B32B 7/12; B32B 15/02; C09J 5/00; C09J 7/26; C09J 7/28; C09J 7/38; C09J 11/08

(52) U.S. Cl. CPC C09J 7/21; B32B 1/00; B32B 7/12; B32B 15/02; C09J 5/00; C09J 7/26; C09J 7/28; C09J 7/38; C09J 7/381; C09J 7/385; C09J 11/08; B32B 2405/00; B32B 2439/40; C09J 2301/124; C09J 2301/408; C09J 2400/10; C09J 2400/143; C09J 2400/163; C09J 2400/243; C09J 2400/263; C09J 2427/008

(57) ABSTRACT

The present invention provides an adhesive sheet that, on one surface, has excellent adhesion to fluororesins such as polytetrafluoroethylene without requiring any pretreatment on the fluororesin and, on the other surface, is capable of suppressing peeling of the substrate. The present invention can also provide a laminate sheet including the adhesive sheet. The present invention can also provide a chemical tank to which the adhesive sheet or the laminate sheet is attached. The present invention can also provide a method for producing a chemical tank using the laminate sheet or the adhesive sheet. Provided is an adhesive sheet including: a substrate; and an adhesive layer (Y1) on one surface of the substrate, the substrate including at least one selected from the group consisting of a non-woven fabric, a glass cloth, a carbon cloth, a metal mesh, and a foam having an open-cell structure, the adhesive sheet having a 180° peeling force at 23 °C. for polytetrafluoroethylene of 5.0 N/25 mm or greater on an adhesive layer (Y1) side of the adhesive sheet.

### TECHNICAL FIELD

The present invention relates to an adhesive sheet. The present invention also relates to a laminate sheet including the adhesive sheet. The present invention also relates to a chemical tank to which the adhesive sheet or the laminate sheet is attached. The present invention also relates to a method for producing a chemical tank using the laminate sheet or the adhesive sheet.

### BACKGROUND ART

Adhesive sheets have been widely used to fix various components. Specifically, for example, adhesive sheets are used to bond a cover panel for protecting a surface of a portable electronic device to a touch panel module or display panel module, or to bond a touch panel module to a display panel module. These adhesive sheets for fixing components are required to have high adhesion, as well as functions such as heat resistance, heat conductivity, and shock resistance according to the environment in which the sheet is used (e.g., Patent Literatures 1 to 3).

### CITATION LIST

### Patent Literature

Patent Literature 1: JP 2015-052050 A
Patent Literature 2: JP 2015-021067 A
Patent Literature 3: JP 2015-120876 A

### SUMMARY OF INVENTION

### Technical Problem

In recent years, the demand for fluororesins has been increasing owing to their excellent heat resistance, chemical resistance, low-dielectric properties, and water repellency. For example, ethylene-tetrafluoroethylene copolymers (ETFE), which have high mechanical strength and excellent processability, are used in a wide range of fields including electric wire coverings and building materials.

The semiconductor and chemical industries use various chemical solutions, including acids and alkalis. These chemical solutions are often stored or disposed of using lined tanks where fluororesin is bonded to the tank body to prevent corrosion. Conventional bonding of fluororesin to a tank body involves applying an adhesive, such as chloroprene rubber or epoxy resin, to both the fluororesin and the tank body, followed by thermal compression bonding.

However, these adhesives require surface pretreatment of the fluororesin to achieve sufficient adhesion strength. Usually, pretreatment typified by chemical etching is performed on the fluororesin to improve adhesion strength. Such pretreatment is not only costly but also may reduce product quality or pose safety and environmental issues. Thus, there has been a demand for adhesive sheets as alternatives that can be bonded without pretreatment.

In the case of using an adhesive sheet to bond fluororesin to a tank body, a non-support sheet, which is an adhesive sheet without a substrate, may exhibit poor workability during attachment of the fluororesin to the adhesive sheet, potentially causing lifting of the adhesive sheet from the interface with the fluororesin. Therefore, it is necessary to ensure the workability during attachment using a support sheet, which is an adhesive sheet with a substrate. Methods for bonding fluororesin to a tank body using a support sheet with a substrate include: (1) a method involving preparing a laminate sheet including a one-sided sheet having an adhesive layer on one side and fluororesin bonded to the adhesive layer of the one-sided sheet, and then bonding the substrate of the one-sided sheet in the laminate sheet to the tank body using adhesive; and (2) a method involving bonding fluororesin and a tank body at once using a double-sided sheet having adhesive layers on both sides.

Unfortunately, in either of the methods (1) and (2), the adhesion strength is higher at the interface between the tank body and the adhesive for bonding the tank body. Therefore, when the adhesive sheet includes a film substrate typified by a PET film, which is a common substrate for adhesive sheets, the adhesion strength may be lower at the interface between the adhesive for bonding the tank body and the substrate, resulting in peeling at the interface between the adhesive for bonding the tank body and the substrate.

The present invention provides an adhesive sheet that, on one surface, has excellent adhesion to fluororesins such as polytetrafluoroethylene without requiring any pretreatment on the fluororesins and, on the other surface, is capable of suppressing peeling of the substrate. The present invention also relates to a laminate sheet including the adhesive sheet. The present invention also provides a chemical tank to which the adhesive sheet or the laminate sheet is attached. The present invention also provides a method for producing a chemical tank using the laminate sheet or the adhesive sheet.

### Solution to Problem

The disclosure 1 relates to an adhesive sheet including: a substrate; and an adhesive layer (Y1) on a first surface of the substrate, the substrate including at least one selected from the group consisting of a non-woven fabric, a glass cloth, a carbon cloth, a metal mesh, and a foam having an open-cell structure, the adhesive sheet having a 180° peeling force at 23 °C for polytetrafluoroethylene of 5.0 N/25 mm or greater on an adhesive layer (Y1) side of the adhesive sheet.

The disclosure 2 relates to the adhesive sheet according to the disclosure 1, further including an adhesive layer (Y2) on another surface of the substrate.

The disclosure 3 relates to the adhesive sheet according to the disclosure 1 or 2, wherein the adhesive layer (Y1) contains a base polymer (P1) and a tackifier resin, and the base polymer (P1) includes at least one selected from the group consisting of a (meth)acrylic copolymer, a styrene elastomer, and a silicone resin.

The disclosure 4 relates to the adhesive sheet according to the disclosure 3, wherein the tackifier resin includes a tackifier resin (T1) that contains at least one structural unit (A) selected from the group consisting of a structural unit (A-1), a structural unit (A-1′), a structural unit (A-2), a structural unit (A-2′), a structural unit (A-3), a structural unit (A-3′), a structural unit (A-4), and a structural unit (A-4′) that are represented by the following formulas.

The disclosure 5 relates to the adhesive sheet according to the disclosure 4, wherein the tackifier resin (T1) further contains a structural unit (B) derived from at least one monomer (b) selected from the group consisting of a terpene monomer and a vinyl monomer.

The disclosure 6 relates to the adhesive sheet according to the disclosure 3, 4, or 5, wherein the tackifier resin includes at least one tackifier resin (T2) selected from the group consisting of a rosin ester resin, a terpene resin, a terpene phenol resin, and a petroleum resin.

The disclosure 7 relates to the adhesive sheet according to the disclosure 1, 2, 3, 4, 5, or 6, wherein the adhesive layer (Y1) has a thickness of 25 μm or greater and 1,000 μm or less.

The disclosure 8 relates to the adhesive sheet according to the disclosure 2, wherein the adhesive sheet has a probe tack value of 2,000 gf/5 mmφ or less on an adhesive layer (Y2) side of the adhesive sheet as measured at 23 °C, a pressuring pressure of 98 gf, a pressuring speed of 100 mm/sec, a pressuring time of 10 seconds, and a withdrawal speed of 5 mm/sec.

The disclosure 9 relates to the adhesive sheet according to the disclosure 2 or 8, wherein the adhesive layer (Y2) has a thickness of 20 μm or greater and 1,000 μm or less.

The disclosure 10 relates to the adhesive sheet according to the disclosure 1, 2, 3, 4, 5, 6, 7, 8, or 9, which is used for lining a tank body of a chemical tank for a semiconductor or of a chemical tank for a chemical industry.

The disclosure 11 relates to a laminate sheet including: the adhesive sheet according to the disclosure 1, 2, 3, 4, 5, 6, 7, 8, 9, or 10; and a fluororesin-containing sheet on a surface of the adhesive layer (Y1), the surface being different from a surface in contact with the substrate.

The disclosure 12 relates to the laminate sheet according to the disclosure 11, which is used for protecting an adherend.

The disclosure 13 relates to the laminate sheet according to the disclosure 12, which is used for protecting an adherend from a chemical liquid.

The disclosure 14 relates to a chemical tank including: a tank body; and the adhesive sheet according to the disclosure 1, 2, 3, 4, 5, 6, 7, 8, or 9, or the laminate sheet according to the disclosure 10, 11, 12, or 13, attached to an inner surface of the tank body.

The disclosure 15 relates to a method for producing a chemical tank for a semiconductor or a chemical tank for a chemical industry, the method including a step of attaching the laminate sheet according to the disclosure 10, 11, 12, or 13 to an inner surface of a tank body of a chemical tank.

The disclosure 16 relates to a method for producing a chemical tank for a semiconductor or a chemical tank for a chemical industry, the method including: a step of producing a laminate sheet by pressure-bonding a fluororesin-containing sheet to the adhesive layer (Y1) of the adhesive sheet according to the disclosure 2, 8, or 9; and a step of attaching the adhesive layer (Y2) of the laminate sheet to an inner surface of a tank body of a chemical tank.

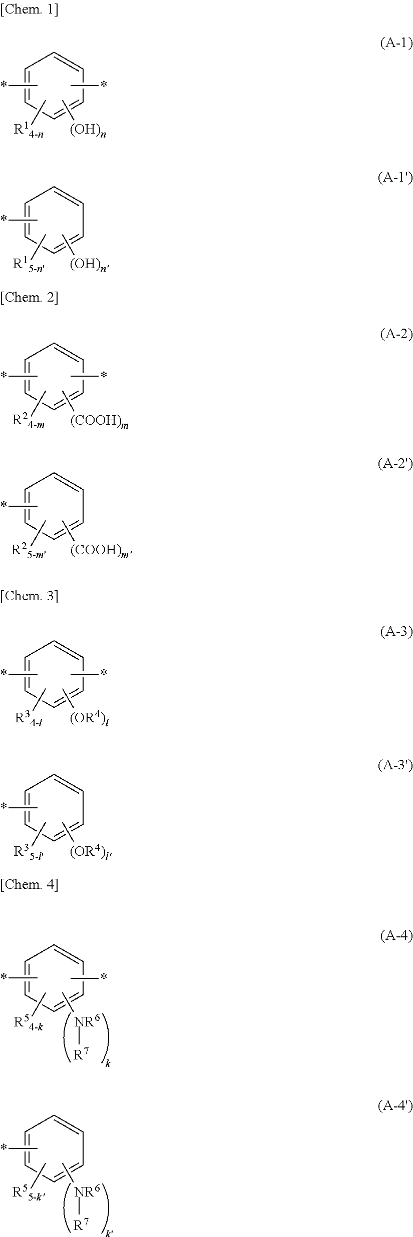

In the formulas, R¹ to R⁷ each represent a hydrogen atom, an aliphatic hydrocarbon group, an aromatic hydrocarbon group, a polar functional group, an aliphatic hydrocarbon group containing a polar functional group, or an aromatic hydrocarbon group containing a polar functional group; n and 1 each represent an integer of 2 or greater and 4 or less; n′ and l′ each represent an integer of 2 or greater and 5 or less; m and k each represent an integer of 1 or greater and 4 or less; m′ and k′ each represent an integer of 1 or greater and 5 or less; and * represents a linking moiety.

The present invention is described in detail below.

The present inventors considered an adhesive sheet including a substrate and an adhesive layer, wherein the adhesive layer has a 180° peel force for polytetrafluoroethylene in a specific range, and the substrate is of a specific type. As a result, the inventors found out that it is possible to provide an adhesive sheet that, on one surface, has excellent adhesion to fluororesins such as polytetrafluoroethylene without requiring any pretreatment on the fluororesins and, on the other surface, is capable of suppressing peeling of the substrate. The present invention is thus completed.

Herein, “adhesion” refers not only to a permanent bonding phenomenon but also to a temporary bonding phenomenon, which is herein referred to as “releasable adhesion”.

The adhesive sheet of the present invention includes a substrate.

When the adhesive sheet of the present invention includes a substrate, the resulting adhesive sheet has excellent workability during attachment.

The substrate includes at least one selected from the group consisting of a non-woven fabric, a glass cloth, a carbon cloth, a metal mesh, and a foam having an open-cell structure. When the substrate includes at least one selected from the group consisting of a non-woven fabric, a glass cloth, a carbon cloth, a metal mesh, and a foam having an open-cell structure, the substrate can have improved anchoring strength. This makes it possible to suppress peeling of the substrate, resulting in highly strong adhesion.

In a one-sided adhesive sheet, air may be trapped at the bonding interface when the substrate of the adhesive sheet is pressure-bonded to the layer of adhesive for bonding to the tank body. Such air may cause the adhesive to be easily peeled off from the substrate. When the substrate includes at least one selected from the group consisting of a non-woven fabric, a glass cloth, a carbon cloth, a metal mesh, and a foam having an open-cell structure, the substrate has a uniform surface structure and provides passages for air. Thus, the air release properties to reduce the above-described trapping of air can be improved, so that peeling of the substrate can be reduced even when adhesive is applied to the substrate.

In particular, from the standpoint of heat resistance and chemical resistance, the substrate preferably includes a glass cloth, a carbon cloth, and/or a metal mesh.

Examples the non-woven fabric include G2260-1S (available from Toray International, Inc.).

Examples of the glass cloth include KS2770 (available from Nitto Boseki Co., Ltd.)

Examples of the carbon cloth include C-540 (available from Hagihara Industries Inc.).

Examples of the metal mesh include NASLON (available from Nippon Seisen, Co., Ltd.) mesh.

Examples of the foam having an open-cell structure include PORON SR-S-70P (available from Inoac Corporation).

The lower limit of the thickness of the substrate is preferably 4 μm, and the upper limit thereof is preferably 500 μm. When the thickness of the substrate is within the range, the resulting adhesive sheet can have improved interlayer strength. The lower limit of the thickness of the substrate is more preferably 12 μm, and the upper limit thereof is more preferably 300 μm. The lower limit is still more preferably 23 μm, and the upper limit is still more preferably 200 μm.

The upper limit of the heat shrinkage of the substrate is preferably 5%. When the heat shrinkage of the substrate is 5% or lower, the substrate is less likely to have dimensional changes in actual use, and peeling after attachment or the like is less likely to occur. The upper limit of the heat shrinkage of the substrate is more preferably 3%, still more preferably 0.5%, most preferably 0%.

The heat shrinkage of the substrate can be measured by the following method, for example.

Specifically, the substrate is cut into a 10-cm square specimen. The specimen is placed in an oven at 120 °C and heated for 10 minutes. The heated specimen is air-cooled to room temperature, and then the length of a side of the specimen is measured. The heat shrinkage is determined using the following equation (1). Here, “Length of one side of specimen before heating” and “Length of one side of specimen after heating” in the equation (1) refer to the length of the same side.

Heat shrinkage (%)=((Length of one side of specimen before heating)−(Length of one side of specimen after heating))/(Length of one side of specimen before heating)×100 (1)

The adhesive sheet of the present invention includes an adhesive layer (Y1) on one surface.

The lower limit of the 180° peeling force at 23 °C of the adhesive layer (Y1) for polytetrafluoroethylene is 5.0 N/25 mm. When the 180° peeling force at 23 °C of the adhesive layer (Y1) for polytetrafluoroethylene is 5.0 N/25 mm or greater, the adhesive sheet of the present invention can have excellent adhesion to fluororesins. The lower limit of the 180° peeling force at 23 °C of the adhesive layer (Y1) for polytetrafluoroethylene is preferably 7.0 N/25 mm, more preferably 10 N/25 mm.

There is no particular upper limit of the 180° peeling force at 23 °C of the adhesive layer (Y1) for polytetrafluoroethylene, but the upper limit is practically about 100 N/25 mm.

The 180° peeling force at 23 °C of the adhesive layer (Y1) for polytetrafluoroethylene can be measured by the following method.

Specifically, the adhesive sheet is cut into a size of 25 mm in width×100 mm in length and then pressure-bonded to a 2-mm-thick polytetrafluoroethylene sheet (e.g., Yodoflon, available from Yodogawa Hu-Tech Co., Ltd.) by moving a 2-kg rubber roller back and forth once thereon at a speed of 300 mm/min. The resulting workpiece is left to stand for aging in an environment at 23 °C and 50% RH for 20 minutes, whereby a test sample is prepared. The obtained test sample is subjected to a 180° peel test in conformity with JIS Z0237 using a tensile tester (e.g., Tensilon, available from Orientec) at 23 °C, 50% RH, and a peel rate of 300 mm/min. The adhesive sheet (Y1) is peeled off from the polytetrafluoroethylene sheet, whereby the 180° peeling force at 23 °C of the adhesive layer (Y1) for polytetrafluoroethylene can be measured.

The 180° peeling force at 23 °C of the adhesive layer (Y1) for polytetrafluoroethylene can be adjusted to the above-described range by, for example, a method of changing the type or structural units of the base polymer (P1) to be contained in the adhesive layer (Y1) (e.g., changing the copolymerization ratio or composition of the base polymer (P1)), a method of adjusting the type or amount of tackifier resin to be contained in the adhesive layer (Y1), a method of increasing the thickness of the adhesive layer (Y1), or a method of changing the substrate.

The adhesive layer (Y1) preferably contains a base polymer (P1).

Examples of the base polymer (P1) include a base polymer including a (meth)acrylic copolymer, a styrene elastomer, a silicone resin, and/or the like. In particular, to provide a broader range of design choices of the adhesive layer (Y1) and to allow the adhesive layer (Y1) to exhibit strong adhesion, the base polymer (P1) preferably includes at least one selected from the group consisting of a (meth)acrylic copolymer and a styrene elastomer.

The “base polymer” herein refers to a polymer that constitutes 50% by mass or more of the polymers having a weight average molecular weight of 50,000 or greater in the adhesive layer.

The (meth)acrylic copolymer preferably contains a structural unit derived from an alkyl (meth)acrylate.

The alkyl (meth)acrylate preferably includes an alkyl (meth)acrylate containing a C4-C12 alkyl group at an ester end. In other words, the (meth)acrylic copolymer preferably contains a structural unit derived from an alkyl (meth)acrylate containing a C4-C12 alkyl group at an ester end. When the (meth)acrylic copolymer contains a structural unit derived from an alkyl (meth)acrylate containing a C4-C12 alkyl group at an ester end, the (meth)acrylic copolymer has a lower glass transition temperature (Tg). As a result, the later-described shear storage modulus at 25 °C of the adhesive layer (Y1) as measured by dynamic viscoelasticity measurement at a frequency of 10 Hz (hereinafter also simply referred to as “the shear storage modulus at 25 °C of the adhesive layer (Y1)”) can be moderately lowered, and the flexibility of the adhesive layer (Y1) can be further improved. The adhesive layer (Y1) thus can have improved adhesion to fluororesins.

The (meth)acrylate herein refers to acrylate or methacrylate.

The “alkyl (meth)acrylate containing an alkyl group at an ester end” herein refers to a (meth)acrylate containing an alkyl group bound to an oxygen atom of an ester bond.

Examples of the alkyl (meth)acrylate containing a C4-C12 alkyl group at an ester end include n-butyl (meth)acrylate, tert-butyl (meth)acrylate, 2-ethylhexyl (meth)acrylate, n-hexyl (meth)acrylate, n-heptyl (meth)acrylate, n-octyl (meth)acrylate, isooctyl (meth)acrylate, n-nonyl (meth)acrylate, isononyl (meth)acrylate, 1-methylheptyl (meth)acrylate, and lauryl (meth)acrylate. In particular, to further improve the adhesion of the adhesive sheet (particularly adhesion to fluororesins), the alkyl (meth)acrylate containing a C4-C12 alkyl group at an ester end preferably includes an alkyl (meth)acrylate containing a C6-C8 alkyl group at an ester end. Each of these alkyl (meth)acrylates containing a C4-C12 alkyl group at an ester end may be used alone, or two or more of them may be used in combination.

In the (meth)acrylic copolymer, the lower limit of the proportion of the structural unit derived from an alkyl (meth)acrylate containing a C4-C12 alkyl group at an ester end is preferably 50% by mass. When the proportion of the structural unit derived from an alkyl (meth)acrylate containing a C4-C12 alkyl group at an ester end is 50% by mass or more, the (meth)acrylic copolymer has a lower glass transition temperature (Tg). As a result, the later-described shear storage modulus at 25 °C of the adhesive layer is moderately lowered, and the flexibility of the adhesive layer (Y1) can be further improved, thus leading to further improved adhesion to fluororesins. The lower limit of the proportion of the structural unit derived from an alkyl (meth)acrylate containing a C4-C12 alkyl group at an ester end is more preferably 90% by mass, still more preferably 95% by mass.

The upper limit of the proportion of the structural unit derived from an alkyl (meth)acrylate containing a C4-C12 alkyl group at an ester end may be 99.99% by mass, but from the standpoint of the bulk cohesion of the adhesive layer (Y1), the upper limit is preferably 99% by mass.

In the (meth)acrylic copolymer, the lower limit of the proportion of a structural unit derived from the alkyl (meth)acrylate containing a C6-C8 alkyl group at an ester end is preferably 50% by mass. When the proportion of the structural unit derived from the alkyl (meth)acrylate containing a C6-C8 alkyl group at an ester end is 50% by mass or more, the (meth)acrylic copolymer has a lower glass transition temperature (Tg). As a result, the later-described shear storage modulus at 25 °C of the adhesive layer (Y1) is moderately lowered, and the flexibility of the adhesive layer (Y1) can be further improved, thus leading to further improved adhesion to fluororesins. The lower limit of the proportion of the structural unit derived from the alkyl (meth)acrylate containing a C6-C8 alkyl group at an ester end is more preferably 85% by mass, still more preferably 90% by mass.

From the standpoint of the bulk cohesion of the adhesive layer (Y1), the upper limit of the proportion of the structural unit derived from an alkyl (meth)acrylate containing a C4-C12 alkyl group at an ester end is preferably 99.5% by mass, more preferably 99% by mass.

The alkyl (meth)acrylate may include a different alkyl (meth)acrylate other than the alkyl (meth)acrylate containing a C4-C12 alkyl group at an ester end.

Examples of the different alkyl (meth)acrylate include methyl (meth)acrylate, ethyl (meth)acrylate, propyl (meth)acrylate, myristyl (meth)acrylate, cetyl (meth)acrylate, stearyl (meth)acrylate, cyclohexyl (meth)acrylate, isobornyl (meth)acrylate, an ester of 5,7,7-trimethyl-2-(1,3,3-trimethylbutyl) octanol-1 and (meth)acrylic acid, an ester of (meth)acrylic acid and an alcohol having one or two methyl groups in a linear backbone and having a total carbon number of 18, behenyl (meth)acrylate, and arachidyl (meth)acrylate. Each of these different alkyl (meth)acrylates may be used alone, or two or more of them may be used in combination.

The (meth)acrylic copolymer preferably further contains a structural unit derived from a polar functional group-containing monomer. When the (meth)acrylic copolymer contains a structural unit derived from a polar functional group-containing monomer, the adhesive layer (Y1) can have high bulk cohesion, and the resulting adhesive sheet can have further improved adhesion.

The polar functional group has reactivity such as cross-linking reactivity. The polar functional group is preferably at least one selected from the group consisting of a carboxy group, a hydroxy group, an amino group, and an epoxy group. In particular, to further contribute to improvement of the adhesion of the resulting adhesive sheet, the polar functional group is more preferably at least one selected from the group consisting of a carboxy group and a hydroxy group. The (meth)acrylic copolymer preferably contains at least one structural unit selected from the group consisting of a structural unit derived from a carboxy group-containing (meth)acrylate and a structural unit derived from a hydroxy group-containing (meth)acrylate.

Example of the carboxy group-containing monomer include (meth)acrylic acid.

Examples of the hydroxy group-containing monomer include 4-hydroxybutyl (meth)acrylate and 2-hydroxyethyl (meth)acrylate.

Example of the epoxy group-containing monomer include glycidyl (meth)acrylate.

Each of these polar functional group-containing monomers may be used alone, or two or more of them may be in combination.

In the (meth)acrylic copolymer, the lower limit of the proportion of the structural unit derived from a carboxy group-containing monomer is preferably 0.01% by mass, and the upper limit thereof is preferably 3.0% by mass. When the proportion of the structural unit derived from a carboxy group-containing monomer is in the range, the bulk cohesion of the adhesive layer (Y1) can be appropriately adjusted, so that the resulting adhesive sheet can have better adhesion. The lower limit of the proportion of the structural unit derived from a carboxy group-containing monomer is more preferably 0.05% by mass, and the upper limit thereof is more preferably 2.0% by mass.

In the (meth)acrylic copolymer, the lower limit of the proportion of the structural unit derived from a hydroxy group-containing monomer is preferably 0.01% by mass, and the upper limit thereof is preferably 3.0% by mass. When the proportion of the structural unit derived from a hydroxy group-containing monomer is in the range, the bulk cohesion of the adhesive layer (Y1) can be appropriately adjusted, so that the resulting adhesive sheet can have better adhesion. The lower limit of the proportion of the structural unit derived from a hydroxy group-containing monomer is more preferably 0.05% by mass, and the upper limit thereof is more preferably 2.0% by mass.

In the (meth)acrylic copolymer, the lower limit of the total proportion of the structural units derived from a polar functional group-containing monomer is preferably 0.01% by mass, and the upper limit thereof is preferably 6.0% by mass. When the total proportion of the structural units derived from a polar functional group-containing monomer is in the range, the bulk cohesion of the adhesive layer (Y1) can be appropriately adjusted, so that the resulting adhesive sheet can have better adhesion. The lower limit of the total proportion of the structural units derived from a polar functional group-containing monomer is more preferably 0.1% by mass, and the upper limit thereof is more preferably 3.0% by mass.

As necessary, the (meth)acrylic copolymer may contain a structural unit derived from a different copolymerizable monomer other than the above-described structural unit derived from an alkyl (meth)acrylate and the above-described structural unit derived from a polar functional group-containing monomer. Examples of the different monomer include benzyl (meth)acrylate, 2-butoxyethyl (meth)acrylate, 2-phenoxyethyl (meth)acrylate, tetrahydrofurfuryl (meth)acrylate, and polypropylene glycol mono(meth)acrylate. Examples of the different monomer also include various monomers used for common acrylic polymers, such as vinyl carboxylates (e.g., vinyl acetate) and styrene. Each of these different monomers may be used alone, or two or more of them may be used in combination.

The lower limit of the weight average molecular weight (Mw) of the (meth)acrylic copolymer is preferably 50,000, and the upper limit thereof is preferably 1,600,000. When the weight average molecular weight (Mw) of the (meth)acrylic copolymer is 50,000 or greater, the adhesive layer (Y1) can have improved bulk cohesion, and the resulting adhesive sheet can have further improved adhesion. When the weight average molecular weight (Mw) of the (meth)acrylic copolymer is 1,600,000 or less, the adhesive layer (Y1) can more closely adhere to fluororesins. The lower limit of the weight average molecular weight (Mw) of the (meth)acrylic copolymer is more preferably 100,000, and the upper limit thereof is more preferably 1,200,000.

The lower limit of the ratio of the weight average molecular weight (Mw) to the number average molecular weight (Mn) of the (meth)acrylic copolymer (molecular weight distribution, Mw/Mn) is preferably 1.05, and the upper limit thereof is preferably 10.0. When the molecular weight distribution (Mw/Mn) of the (meth)acrylic copolymer is 1.05 or greater, the adhesive layer (Y1) can have further improved flexibility, and the resulting adhesive sheet can have further improved adhesion to fluororesins. When the molecular weight distribution (Mw/Mn) of the (meth)acrylic copolymer is 10.0 or less, the proportion of low-molecular components is low, so that the adhesive layer (Y1) can have improved bulk cohesion, and the resulting adhesive sheet can have further improved adhesion. The upper limit of the molecular weight distribution (Mw/Mn) of the (meth)acrylic copolymer is more preferably 9.0, still more preferably 8.0, further more preferably 7.0.

The weight average molecular weight (Mw) and the number average molecular weight (Mn) herein refer to the weight average molecular weights measured in terms of standard polystyrene by gel permeation chromatography (GPC). Specifically, the (meth)acrylic copolymer is diluted 50-fold with tetrahydrofuran (THF), and the dilute is passed through a filter (material: polytetrafluoroethylene, pore size: 0.2 μm). The obtained filtrate is supplied to a gel permeation chromatograph (e.g., 2690 Separations Module, available from Waters) and subjected to GPC measurement at a sample flow rate of 1 mL/min and a column temperature of 40 °C. The molecular weight of the (meth)acrylic copolymer in terms of polystyrene is measured, and the weight average molecular weight (Mw) and the number average molecular weight (Mn) are determined.

The column may be GPC KF-802.5L (available from Showa Denko K.K.), for example. The detector may be a differential refractometer, for example. The molecular weight distribution (Mw/Mn) can be determined using the obtained weight average molecular weight (Mw) and number average molecular weight (Mn).

The weight average molecular weight (Mw) and the molecular weight distribution (Mw/Mn) of the (meth)acrylic copolymer may be adjusted to the above range by adjusting the composition, polymerization method, or polymerization conditions of the (meth)acrylic copolymer, for example.

The lower limit of the glass transition temperature (Tg) of the (meth)acrylic copolymer is preferably-70 °C, and the upper limit thereof is preferably −30 °C. When the glass transition temperature of the (meth)acrylic copolymer is in the range, the later-described shear storage modulus at 25 °C of the adhesive layer (Y1) can be easily adjusted to an appropriate range, so that the resulting adhesive sheet can have better adhesion to fluororesins. The lower limit of the glass transition temperature (Tg) of the (meth)acrylic copolymer is more preferably-60 °C, and the upper limit thereof is more preferably-40 °C.

The glass transition temperature herein can be measured using a differential scanning calorimeter (e.g., SII Exstar 6000/DSC 6220, available from Hitachi High-Tech Science Corporation) in a nitrogen atmosphere at a temperature increase rate of 10 °C/min. The value obtained in the first run can be used as the glass transition temperature.

The (meth)acrylic copolymer can be synthesized using a conventionally known polymerization method including radically reacting, in the presence of a polymerization initiator, the monomers from which the structural units described above are derived. Examples of the polymerization method include solution polymerization (boiling point polymerization or constant temperature polymerization), emulsion polymerization, suspension polymerization, and bulk polymerization. In particular, solution polymerization is preferred because it allows easy synthesis.

In the case of using solution polymerization as the polymerization method, examples of a reaction solvent include ethyl acetate, toluene, methyl ethyl ketone, methyl sulfoxide, ethanol, acetone, and diethyl ether. Each of these reaction solvents may be used alone, or two or more of them may be used in combination.

Examples of the polymerization initiator include organic peroxides and azo compounds.

Examples of the organic peroxides include 1,1-bis(t-hexylperoxy)-3,3,5-trimethylcyclohexane, t-hexyl peroxypivalate, t-butyl peroxypivalate, 2,5-dimethyl-2,5-bis(2-ethylhexanoylperoxy) hexane, t-hexyl peroxy-2-ethylhexanoate, t-butyl peroxy-2-ethylhexanoate, t-butyl peroxyisobutyrate, t-butyl peroxy-3,5,5-trimethylhexanoate, and t-butyl peroxylaurate.

Examples of the azo compounds include azobisisobutyronitrile and azobiscyclohexanecarbonitrile.

Each of these polymerization initiators may be used alone, or two or more of them may be used in combination.

The styrene elastomer is not limited as long as it is a block copolymer that includes a block derived from a styrene monomer and a block derived from a conjugated diene monomer, has rubber elasticity at room temperature, and includes a hard segment and a soft segment. Here, the block derived from a styrene monomer is a hard segment, and the block derived from a conjugated diene monomer is a soft segment.

Examples of the styrene monomer include styrene, 2-methylstyrene, 3-methylstyrene, 4-methylstyrene, α-methylstyrene, 2,4-dimethylstyrene, 2,4-diisopropylstyrene, 4-t-butylstyrene, 5-t-butyl-2-methylstyrene, vinylethylbenzene, divinylbenzene, trivinylbenzene, divinylnaphthalene, t-butoxystyrene, vinylbenzyldimethylamine, (4-vinylbenzyl)dimethylaminoethyl ether, N,N-dimethylaminoethylstyrene, N,N-dimethylaminomethylstyrene, 2-ethylstyrene, 3-ethylstyrene, 4-ethylstyrene, 2-t-butylstyrene, 3-t-butylstyrene, 4-t-butylstyrene, vinylxylene, vinylnaphthalene, vinylpyridine, diphenylethylene, and diphenylethylene containing a tertiary amino group. Preferred among these is styrene because it is industrially easily available.

Examples of the diphenylethylene containing a tertiary amino group include 1-(4-N,N-dimethylaminophenyl)-1-phenylethylene.

Each of these styrene monomers may be used alone, or two or more of them may be used in combination.

Examples of the conjugated diene monomer include isoprene, 1,3-butadiene, 2,3-dimethyl-1,3-butadiene, 1,3-pentadiene, 1,3-hexadiene, 1,3-heptadiene, 2-phenyl-1,3-butadiene, 3-methyl-1,3-pentadiene, and 2-chloro-1,3-butadiene. Preferred among these are 1,3-butadiene and isoprene, which have high polymerization reactivity and are industrially easily available.

Each of these conjugated diene monomers may be used alone, or two or more of them may be used in combination.

Specific examples of the styrene elastomer include styrene-isoprene-styrene (SIS) block copolymers, styrene-butadiene-styrene (SBS) block copolymers, styrene-chloroprene-styrene block copolymers, styrene-ethylene-butylene-styrene copolymers (SEBS), and styrene-ethylene-propylene-styrene copolymers (SEPS). In particular, for the resulting adhesive sheet to easily exhibit high adhesion and not to be easily peeled off from an adherend even when immersed in an alkaline chemical liquid, SIS block copolymers and SBS block copolymers are preferred, and SIS block copolymers are more preferred. Each of these styrene elastomers may be used alone, or two or more of them may be in combination.

The styrene elastomer may include a diblock copolymer of the block derived from a styrene monomer and the block derived from a conjugated diene monomer in addition to a triblock copolymer of the block derived from a styrene monomer and the block derived from a conjugated diene monomer.

The lower limit of the percentage of the diblock copolymer (hereinafter also referred to as “the diblock proportion”) in the styrene elastomer is preferably 50% by mass. When the diblock proportion is 50% by mass or more, the adhesive layer (Y1) can more closely adhere to an adherend, and the resulting adhesive sheet can have further improved adhesion. Moreover, the later-described shear storage modulus at 25 °C of the adhesive layer (Y1) can be moderately lowered, and the flexibility of the adhesive layer (Y1) can be further improved. The adhesive layer (Y1) thus can have improved adhesion to fluororesins. The lower limit of the diblock proportion is more preferably 70% by mass.

To further improve the cohesion of the adhesive layer (Y1), the upper limit of the diblock proportion is preferably 90% by mass.

The diblock proportion can be calculated from the peak area ratio of the copolymers measured by gel permeation chromatography (GPC).

The upper limit of the amount of the block derived from a styrene monomer (hereinafter also referred to as “the styrene content”) is preferably 20% by mass. When the styrene content is 20% by mass or less, the adhesive layer (Y1) is not excessively hard and can more closely adhere to an adherend, and the resulting adhesive sheet can have further improved adhesion. The upper limit of the styrene content is more preferably 16% by mass.

To further improve the cohesion of the adhesive layer (Y1), the lower limit of the styrene content is preferably 8% by mass.

The styrene content can be calculated from the peak area ratio of the blocks measured by ¹H-NMR.

The lower limit of the weight average molecular weight of the styrene elastomer is preferably 50,000, and the upper limit thereof is preferably 600,000. When the weight average molecular weight of the styrene elastomer is 50,000 or greater, the adhesive layer (Y1) can have increased bulk strength, and the resulting adhesive sheet can have further improved adhesion. When the weight average molecular weight of the styrene elastomer is 600,000 or less, the compatibility of the styrene elastomer with other components can be further improved. The lower limit of the weight average molecular weight of the styrene elastomer is more preferably 100,000, and the upper limit thereof is more preferably 500,000

Examples of the silicone resin include KR-3700 (available from Shin-Etsu Chemical Co., Ltd.).

The lower limit of the proportion of the base polymer (P1) in the adhesive layer (Y1) is preferably 30% by mass, and the upper limit thereof is preferably 99.5% by mass. When the proportion of the base polymer (P1) is in the range, the adhesive layer (Y1) can have further improved adhesion to fluororesins. The lower limit of the proportion of the base polymer (P1) is more preferably 40% by mass, and the upper limit thereof is more preferably 99% by mass. The lower limit is still more preferably 50% by mass, and the upper limit is still more preferably 95% by mass.

The adhesive layer (Y1) preferably contains a tackifier resin.

The tackifier resin preferably includes a tackifier resin (T1) containing at least one structural unit (A) selected from the group consisting of a structural unit (A-1), a structural unit (A-1′), a structural unit (A-2), a structural unit (A-2′), a structural unit (A-3), a structural unit (A-3′), a structural unit (A-4), and a structural unit (A-4′) that are represented by the formulas above. When the adhesive layer (Y1) contains the tackifier resin (T1), the adhesive layer (Y1) can have higher adhesion, particularly to low-polarity adherends (e.g., fluororesins).

In particular, to greatly enhance the interactions with an adherend to further enhance the adhesion to the adherend, the structural unit (A) is preferably at least one selected from the group consisting of the structural unit (A-1), the structural unit (A-1′), the structural unit (A-2), the structural unit (A-2′), the structural unit (A-3), and the structural unit (A-3′), more preferably at least one selected from the group consisting of the structural unit (A-1) and the structural unit (A-1′). When the structural unit (A) is at least one selected from the group consisting of the structural unit (A-1) and the structural unit (A-1′), the interactions with an adherend can be further greatly enhanced. Moreover, such a structural unit (A) is preferred in terms of saving petroleum resources because the later-described monomers containing bio-derived material can be easily used to constitute the structural unit (A-1) and the structural unit (A-1′). Further, such a structural unit (A) allows the tackifier resin (T1) to have moderate polarity, and thus in the case that the base polymer (P1) is a (meth)acrylic copolymer, the tackifier resin (T1) can have better compatibility with the (meth)acrylic copolymer.

The tackifier resin (T1) may have the structural unit (A) in a side chain or in the backbone structure or at an end of the backbone structure. In particular, to achieve suitable physical properties required for use as a tackifier resin, the tackifier resin (T1) preferably has the structural unit (A) in the backbone structure or at an end of the backbone structure.

In the structural unit (A), R¹ to R⁷ each represent a hydrogen atom, an aliphatic hydrocarbon group, an aromatic hydrocarbon group, a polar functional group, an aliphatic hydrocarbon group containing a polar functional group, or an aromatic hydrocarbon group containing a polar functional group.

Examples of the aliphatic hydrocarbon group include C1-C20 linear, branched, or cyclic alkyl groups. Examples of the aromatic hydrocarbon group include substituted or non-substituted C1-C20 aryl groups.

The polar functional group is not limited. R¹ may be a polar functional group other than a hydroxy group. R² may be a polar functional group other than a carboxy group. R³ may be a polar functional group other than a group represented by OR⁴. R⁵ may be a polar functional group other than a group represented by NR⁶R⁷. Specific examples of the polar functional group include amino, carboxy, carbonyl, alkoxy, hydroxy, nitrile, and nitro groups.

Examples of the aliphatic hydrocarbon group containing a polar functional group include a group obtained by replacing one or more hydrogen atoms of any of the above aliphatic hydrocarbon groups with any of the above polar functional groups. Examples of the aromatic hydrocarbon group containing a polar functional group include a group obtained by replacing one or more hydrogen atoms of any of the above aromatic hydrocarbon groups with any of the above polar functional groups.

In the tackifier resin (T1), multiple R¹s contained in one structural unit (A-1) may be the same as or different from each other. Multiple R⁵s contained in different structural units (A-1) may also be the same as or different from each other. Similarly, multiple R⁵s contained in different structural units (A-1′) may also be the same as or different from each other. Multiple R⁵s contained in different structural units (A-1′) may also be the same as or different from each other.

Similarly, multiple R²s contained in one structural unit (A-2) may be the same as or different from each other. Multiple R²s contained in different structural units (A-2) may also be the same as or different from each other. Similarly, multiple R²s contained in one structural unit (A-2′) may be the same as or different from each other. Multiple R²s contained in different structural units (A-2′) may also be the same as or different from each other.

Similarly, multiple R³s contained in one structural unit (A-3) may be the same as or different from each other. Multiple R³s contained in different structural units (A-3) may also be the same as or different from each other. Similarly, multiple R³s contained in one structural unit (A-3′) may be the same as or different from each other. Multiple R³s contained in different structural units (A-3′) may also be the same as or different from each other.

Similarly, multiple R⁴s contained in one structural unit (A-3) may be the same as or different from each other. Multiple R⁴s contained in different structural units (A-3) may also be the same as or different from each other. Similarly, multiple R⁴s contained in one structural unit (A-3′) may be the same as or different from each other. Multiple R⁴s contained in different structural units (A-3′) may also be the same as or different from each other.

Similarly, multiple R⁵s contained in one structural unit (A-4) may be the same as or different from each other. Multiple R⁵s contained in different structural units (A-4) may also be the same as or different from each other. Similarly, multiple R⁵s contained in one structural unit (A-4′) may be the same as or different from each other. Multiple R⁵s contained in different structural units (A-4′) may also be the same as or different from each other.

Similarly, multiple R⁶s and R⁷s contained in one structural unit (A-4) may be the same as or different from each other. Multiple R⁵s and R⁷s contained in different structural units (A-4) may also be the same as or different from each other. Similarly, multiple R⁵s and R⁷s contained in one structural unit (A-4′) may be the same as or different from each other. Multiple R⁵s and R⁷s contained in different structural units (A-4′) may also be the same as or different from each other.

In the structural unit (A), n and 1 each may be any integer of 2 or greater and 4 or less, and n′ and l′ are each may be any integer of 2 or greater and 5 or less. From the standpoint of easy availability of raw materials, n, 1, n′, and l′ are preferably 2 or 3, and n, 1, n′, and l′ are more preferably 3 because then the adhesion of the adhesive layer (Y1) can be further enhanced.

In the structural unit (A), m and k each may be any integer of 1 or greater and 4 or less, and m′ and k′ each may be any integer of 1 or greater and 5 or less. From the standpoint of easy availability of raw materials, m, k, m′, and k′ are preferably 1, 2, or 3, and m, k, m′, and k′ are more preferably 1 because then the adhesion of the adhesive layer (Y1) can be further enhanced.

Specific examples of the structural unit (A-1) and the structural unit (A-1′) include structural units derived from dihydroxybenzenes or their derivatives (n and n′ are 2) and structural units derived from trihydroxybenzenes or their derivatives (n and n′ are 3). Each of these structural units may be used alone, or two or more of them may be used in combination.

Examples of the dihydroxybenzenes or their derivatives include resorcinol, pyrocatechol, hydroquinone, dihydroxytoluene, dihydroxyxylene, dihydroxyphenyl ethylamine hydrochloride, dihydroxybenzoic acid, dihydroxyphenylacetic acid, dihydroxyhydrocinnamic acid, dihydroxyphenylpropionic acid, dihydroxyphenylalanine, dihydroxybenzaldehyde, dihydroxyacetophenone, diacetyldihydroxybenzene, dihydroxyphenyl-2-butanone, methyl dihydroxyphenyl acetate, benzyl dihydroxyphenyl ketone, dihydroxybenzamide, dihydroxymethoxybenzene, dihydroxybenzyl alcohol, dihydroxyphenyl ethanol, dihydroxyphenyl glycol, dihydroxyphenyl acetonitrile, and dihydroxynitrobenzene. Preferred among these is pyrocatechol, which has less steric hindrance and easily interacts with adherends. Each of these dihydroxybenzenes or their derivatives may be used alone, or two or more of them may be used in combination.

Examples of the trihydroxybenzenes or their derivatives include pyrogallol, 1,2,4-trihydroxybenzene, phloroglucinol, trihydroxytoluene, trihydroxydiphenylmethane, 6-hydroxy-L-DOPA, gallic acid, methyl gallate, butyl gallate, isobutyl gallate, isoamyl gallate, hexadecyl gallate, stearyl gallate, trihydroxyacetophenone, trihydroxyphenylethanone, trihydroxyphenylbutanone, trihydroxybenzaldehyde, trihydroxybenzamide, and trihydroxynitrobenzene. Preferred among these is pyrogallol, which has less steric hindrance and easily interacts with adherends. Each of these trihydroxybenzenes or their derivatives may be used alone, or two or more of them may be used in combination.

Specific examples of the structural unit (A-2) and the structural unit (A-2′) include structural units derived from benzoic acid, salicylic acid, dihydroxybenzoic acid, gallic acid, 2-methylbenzoic acid, 3-methylbenzoic acid, 4-methylbenzoic acid, 2-ethylbenzoic acid, 3-ethylbenzoic acid, 4-ethylbenzoic acid, 4-tert-butylbenzoic acid, 2-vinylbenzoic acid, 3-vinylbenzoic acid, 4-vinylbenzoic acid, 4,4′-stilbenedicarboxylic acid, or their derivatives. Preferred among these is 4-vinylbenzoic acid, which has less steric hindrance and easily interacts with adherends. Each of these structural units may be used alone, or two or more of them may be used in combination.

Specific examples of the structural unit (A-3) and the structural unit (A-3′) include structural units derived from dialkoxybenzenes or their derivatives (1 and l′ are 2) and structural units derived from trialkoxybenzenes or their derivatives (1 and l′ are 3).

Examples of the dialkoxybenzenes or their derivatives include 1,2-dimethoxybenzene, 1,3-dimethoxybenzene, and 1,4-dimethoxybenzene. Examples of the trialkoxybenzenes or their derivatives include 1,2,3-trimethoxybenzene, 1,2,4-trimethoxybenzene, and 1,3,5-trimethoxybenzene. Preferred among these is 1,2,3-trimethoxybenzene, which has less steric hindrance and easily interacts with adherends. Each of these trialkoxybenzenes or their derivatives may be used alone, or two or more of them may be used in combination.

Specific examples of the structural unit (A-4) and the structural unit (A-4′) include structural units derived from aminobenzenes or their derivatives (k and k′ are 1). Examples of the aminobenzenes or their derivatives include aniline, methylaniline, ethylaniline, dimethylaniline, and diethylaniline. Each of these aminobenzenes or their derivatives may be used alone, or two or more of them may be used in combination.

The structural unit (A) may consist only of a petroleum-derived material but preferably contains a bio-derived material. The depletion of petroleum resources and the emission of carbon dioxide from the combustion of petroleum-derived products have been of concern. Attempts have been made to conserve petroleum resources by substituting bio-derived materials for petroleum-derived materials. The structural unit (A) containing a bio-derived material is preferable to save petroleum resources. The structural unit (A) containing a bio-derived material is also preferable to reduce carbon dioxide emissions because combusting bio-derived materials, which originally develop by incorporating atmospheric carbon dioxide therein, is not considered to increase the total amount of atmospheric carbon dioxide.

Examples of a monomer that constitutes the structural unit (A) containing a bio-derived material include resorcinol, dihydroxyphenyl ethylamine hydrochloride, dihydroxyhydrocinnamic acid, dihydroxyphenylalanine, dihydroxybenzaldehyde, dihydroxybenzyl alcohol, pyrogallol, 1,2,4-trihydroxybenzene, phloroglucinol, 6-hydroxy-L-DOPA, gallic acid, methyl gallate, butyl gallate, isobutyl gallate, isoamyl gallate, hexadecyl gallate, stearyl gallate, trihydroxyacetophenone, trihydroxybenzaldehyde, trihydroxybenzamide, and trihydroxynitrobenzene.

The structural unit (A) content (mole basis) of the tackifier resin (T1) is not limited. The lower limit thereof is preferably 1 mol %, and the upper limit thereof is preferably 60 mol %. When the structural unit (A) content is 1 mol % or more, adding the tackifier resin (T1) to the adhesive layer (Y1) can further enhance the adhesion of the adhesive layer (Y1). When the structural unit (A) content is 60 mol % or less, the tackifier resin (T1) can have suitable physical properties required for use as a tackifier resin. The lower limit of the structural unit (A) content is more preferably 5 mol %, and the upper limit thereof is more preferably 50 mol %. The lower limit is still more preferably 10 mol %, and the upper limit is still more preferably 30 mol %. The structural unit (A) content (mass basis) of the tackifier resin (T1) is not limited. The lower limit thereof is preferably 0.9% by mass, and the upper limit thereof is preferably 60% by mass. When the structural unit (A) content is 0.9 mol % or more, adding the tackifier resin (T1) to the adhesive layer (Y1) can further enhance the adhesion of the adhesive layer (Y1). When the structural unit (A) content is 60% by mass or less, the tackifier resin (T1) can have suitable physical properties required for use as a tackifier resin. The lower limit of the structural unit (A) content is more preferably 5% by mass, and the upper limit thereof is more preferably 50% by mass. The lower limit is still more preferably 10% by mass, and the upper limit is still more preferably 30% by mass.

The tackifier resin (T1) preferably contains a structural unit (B) derived from at least one monomer (b) selected from the group consisting of a terpene monomer and a vinyl monomer. When the adhesive layer (Y1) contains the structural unit (B), the adhesion of the adhesive layer (Y1) can be further enhanced.

To improve the compatibility of the tackifier resin (T1) and the base polymer, the structural unit (B) is preferably a structural unit derived from a terpene monomer.

Structural units derived from terpene monomers contain aliphatic hydrocarbon groups with unsaturated double bonds. Thus, when the tackifier resin (T1) contains a structural unit derived from a terpene monomer, the compatibility of the tackifier resin (T1) with the base polymer (P1) is improved, reducing a decrease in the adhesion of the adhesive layer (Y1) caused by deterioration of the compatibility.

Examples of the terpene monomer include α-pinene, β-pinene, limonene, dipentene, δ-3-carene, dimethyl octatriene, allo-ocimene, myrcene, ocimene, linalool, and cosmene. In particular, the terpene monomer is preferably α-pinene, β-pinene, or limonene because then the adhesion of the adhesive layer (Y1) can be further enhanced. The vinyl monomer is not limited. To improve the compatibility of the tackifier resin (T1) with the base polymer (P1), the vinyl monomer is preferably free of a structure containing two or more aromatic rings in a molecule (e.g., a naphthalene structure, an anthracene structure, a biphenyl structure, an anthraquinone structure, a benzophenone structure). Examples of vinyl monomers free of a structure containing two or more aromatic rings in a molecule include ethylene, propylene, butylene, hexene, vinyl acetate, vinyl chloride, styrene, α-methylstyrene, coumarone, indene, vinyl toluene, divinylbenzene, divinyl toluene, and 2-phenyl-2-butene. In particular, the vinyl monomer is preferably styrene because then the adhesion of the adhesive layer (Y1) can be further enhanced.

Each of these monomers (b) may be used alone, or two or more of them may be used in combination.

The structural unit (B) may consist only of a petroleum-derived material but preferably contains a bio-derived material. The depletion of petroleum resources and the emission of carbon dioxide from the combustion of petroleum-derived products have been of concern. Attempts have been made to conserve petroleum resources by substituting bio-derived materials for petroleum-derived materials. The structural unit (B) containing a bio-derived material is preferable to save petroleum resources. The structural unit (B) containing a bio-derived material is also preferable to reduce carbon dioxide emissions because combusting bio-derived materials, which originally develop by incorporating atmospheric carbon dioxide therein, is not considered to increase the total amount of atmospheric carbon dioxide.

Examples of the monomer (b) that constitutes the structural unit (B) containing a bio-derived material include terpene monomers, ethylene, propylene, and hexene.

The structural unit (B) content of the tackifier resin (T1) is not limited. The lower limit thereof is preferably 40 mol %, and the upper limit thereof is preferably 99 mol %. When the structural unit (B) content is 40 mol % or more, the tackifier resin (T1) can have suitable physical properties required for use as a tackifier resin. When the structural unit (B) content is 99 mol % or less, the tackifier resin (T1) can have a sufficient structural unit (A) content, and thus can further enhance the adhesion of the adhesive layer (Y1), particularly even to low-polarity adherends. The lower limit of the structural unit (B) content is more preferably 50 mol %, and the upper limit thereof is more preferably 90 mol %.

The tackifier resin (T1) may be any compound containing the structural unit (A), but is preferably a copolymer having a structure represented by the formula below. In the case of containing the structural unit (A) in the backbone structure or at an end of the backbone structure, the tackifier resin (T1) is preferably a copolymer having a structure represented by the formula below.

A copolymer having such a structure can be obtained by a method that uses cationic polymerization described later. The copolymer can further enhance the adhesion of the adhesive layer (Y1), particularly even to low-polarity adherends.

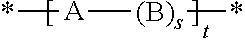

In the formula, A represents the structural unit (A); B represents the structural unit (B); and s and t each represent an integer of 1 or greater. Here, * represents a linking moiety.

The tackifier resin (T1) may be any compound containing the structural unit (A), but is preferably a copolymer containing the structural unit (A) and the structural unit (B), and may further contain a different structural unit. In the copolymer, the structural unit (A) and the structural unit (B) may be randomly copolymerized, or may be regularly or periodically copolymerized as in the case where, for example, they each form a block segment and the block segments bond to each other.

The tackifier resin (T1) preferably further contains an aliphatic hydrocarbon group having an unsaturated double bond. In the tackifier resin (T1), the aliphatic hydrocarbon group having an unsaturated double bond may be in the structural unit (A) or the structural unit (B) or in a different structural unit. From the standpoint of ease of synthesis and improvement in the compatibility of the tackifier resin (T1) with the base polymer (P1), particularly the compatibility of the tackifier resin (T1) with the styrene elastomer, the aliphatic hydrocarbon group having an unsaturated double bond is preferably in the structural unit (B) or in a different structural unit. Such a structural unit (B) or different structural unit that contains the aliphatic hydrocarbon group having an unsaturated double bond is not limited but is preferably a structural unit (B) derived from at least one monomer (b) selected from the group consisting of a terpene monomer and a vinyl monomer. In other words, in the tackifier resin (T1), the aliphatic hydrocarbon group having an unsaturated double bond is preferably in a structural unit (B) derived from at least one monomer (b) selected from the group consisting of a terpene monomer and a vinyl monomer. In particular, in the tackifier resin (T1), the aliphatic hydrocarbon group having an unsaturated double bond is preferably in a structural unit derived from a terpene monomer because then the adhesion of the adhesive layer (Y1) can be further enhanced.

Examples of the different structural unit include: a structural unit that is derived from a different phenol monomer and not encompassed by the structural unit (A); and a structural unit derived from maleic anhydride.

Examples of the different monomer include phenol, cresol, xylenol, propyl phenol, nonyl phenol, methoxy phenol, bromophenol, bisphenol A, bisphenol F, bisphenol S, and dihydroxynaphthalene. Each of these different phenol monomers may be used alone, or two or more of them may be used in combination.

The molecular weight of the tackifier resin (T1) is not limited. The lower limit of the weight average molecular weight (Mw) is preferably 400, and the upper limit thereof is preferably 10,000. When the weight average molecular weight (Mw) of the tackifier resin (T1) is in the range, the tackifier resin (T1) can have suitable physical properties required for use as a tackifier resin. The lower limit of the weight average molecular weight (Mw) of the tackifier resin (T1) is more preferably 500, and the upper limit thereof is more preferably 5,000. The lower limit is still more preferably 700, and the upper limit is still more preferably 3,000.

The weight average molecular weight (Mw) may be adjusted to the above range by, for example, adjusting the composition, polymerization method, or polymerization conditions of the tackifier resin (T1).

The lower limit of the Young's modulus at 25 °C of the tackifier resin (T1) is preferably 10 MPa. When the Young's modulus at 25 °C of the tackifier resin (T1) is 10 MPa or greater, the tackifier resin (T1) can have sufficient hardness and suitable physical properties required for use as a tackifier resin. The lower limit of the Young's modulus at 25 °C of the tackifier resin (T1) is more preferably 50 MPa, still more preferably 70 MPa.

To reduce a decrease in adhesion caused by excessive hardness of the adhesive layer (Y1), the upper limit of the Young's modulus at 25 °C of the tackifier resin (T1) is preferably 10,000 MPa, more preferably 5,000 MPa.

The Young's modulus at 25 °C of the tackifier resin (T1) can be measured using a tensile tester (e.g., Tensilon, available from Orientec) by a tensile test at a peeling rate of 200 mm/min, a grip distance of 15 mm, and 25 °C. The measurement sample for the test may be prepared by, for example, filling a mold having a size of 10×50 mm with the tackifier resin (T1), melting the resin at a temperature 100 °C higher than the glass transition temperature, and forming a specimen having a thickness of 1 mm.

The Young's modulus at 25 °C of the tackifier resin (T1) may be adjusted to the above range by, for example, adjusting the molecular weight or weight average molecular weight of the tackifier resin (T1), the composition of the structural unit (A) and the structural unit (B) in the tackifier resin (T1), or the structural unit (A) and structural unit (B) contents.

The lower limit of the glass transition temperature of the tackifier resin (T1) is preferably 0 °C, and the upper limit thereof is preferably 200 °C. When the glass transition temperature of the tackifier resin (T1) is in the range, the Young's modulus at 25 °C of the tackifier resin (T1) can be easily adjusted to the range described above, so that the tackifier resin (T1) can have suitable physical properties required for use as a tackifier resin. The lower limit of the glass transition temperature of the tackifier resin (T1) is more preferably 10 °C, and the upper limit thereof is more preferably 150 °C.

The lower limit of the iodine value of the tackifier resin (T1) is preferably 2 g/100 g, and the upper limit thereof is preferably 180 g/100 g. When the iodine value of the tackifier resin (T1) is 2 g/100 g or greater, it is possible to more easily reduce a decrease in adhesion of the adhesive layer (Y1) caused by deterioration of the compatibility of the tackifier resin (T1) with the base polymer (P1). When the iodine value of the tackifier resin (T1) is 180 g/100 g or less, the adhesion of the adhesive layer (Y1), particularly even to low-polarity adherends, can be further enhanced. The lower limit of the iodine value of the tackifier resin (T1) is more preferably 70 g/100 g, and the upper limit thereof is more preferably 170 g/100 g.

The iodine value is an index of the amount of unsaturated double bonds (C═C bond content) and herein refers to an iodine value measured in conformity with the method described in JIS K 0070:1992.

The lower limit of the bio-derived carbon (carbon atom) content in the carbon (carbon atoms) in the tackifier resin (T1) is preferably 10%. A bio-derived carbon content of 10% or greater is an indicator of a “bio-based product”.

The tackifier resin (T1) preferably has a bio-derived carbon content of 10% or greater to save petroleum resources and reduce carbon dioxide emissions. The lower limit of the bio-derived carbon content of the tackifier resin (T1) is more preferably 30%, still more preferably 60%, further more preferably 70%, particularly preferably 90%. The upper limit of the bio-derived carbon content of the tackifier resin (T1) is not limited and may be 100%.

While bio-derived carbon contains a certain proportion of radioisotope (C-14), petroleum-derived carbon hardly contains C-14. Hence, the bio-derived carbon content of the tackifier resin (T1) can be calculated by measuring the C-14 concentration in the compound. Specifically, the bio-derived carbon content can be measured in conformity with ASTM D6866-22, a standard widely used in the bioplastics industry.

The tackifier resin (T1) encompasses hydrogenated products of the compounds described above. A hydrogenated product is a compound obtained by saturating at least some of the carbon-carbon double bonds in the above-described tackifier resin (T1) by hydrogenation. In other words, the adhesive layer (Y1) may contain a hydrogenated product in which some of the carbon-carbon double bonds of the tackifier resin (T1) have been hydrogenated, or the adhesive layer (Y1) may contain a hydrogenated product in which all the carbon-carbon double bonds in the tackifier resin (T1) have been hydrogenated. Such a hydrogenated product also can be suitably used as a tackifier resin to be added to the adhesive layer (Y1) and can enhance the adhesion of the adhesive layer (Y1), particularly even to low-polarity adherends.

The tackifier resin (T1) may be produced by any method. The tackifier resin (T1) containing the structural unit (A) in the backbone structure or at an end of the backbone structure is preferably produced as follows, for example. Specifically, the tackifier resin (T1) is preferably produced by a method of copolymerizing a monomer (a) for constituting the structural unit (A) and at least one monomer (b) for constituting the structural unit (B), the at least one monomer (b) being selected from the group consisting of a terpene monomer and a vinyl monomer (hereinafter this method is also referred to as the production method [I]).

The monomer (a) is preferably at least one selected from the group consisting of a monomer (a-1), a monomer (a-2), a monomer (a-3), and a monomer (a-4) that are represented by the following formulas.

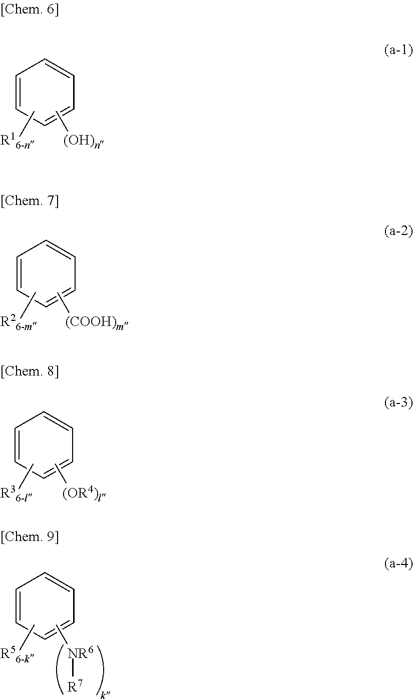

In the formulas (a-1) to (a-4), R¹ to R⁷ each represent a hydrogen atom, an aliphatic hydrocarbon group, an aromatic hydrocarbon group, a polar functional group, an aliphatic hydrocarbon group containing a polar functional group, or an aromatic hydrocarbon group containing a polar functional group; n″ represents an integer of 2 or greater and 5 or less, particularly preferably 2 or 3, more preferably 3; m″ is an integer of 1 or greater and 5 or less; 1″ represents an integer of 2 or greater and 5 or less; and k″ represents an integer of 1 or greater and 5 or less.

In the production method [I] of the tackifier resin (T1), the monomer (a) and the monomer (b) are preferably copolymerized by cationic polymerization.

Cationic polymerization enables the copolymerization of the monomer (a) and the monomer (b) without the need for prior protection of the functional groups of the monomer (a), such as a phenolic hydroxy group, a carboxy group, an alkoxy group, or an amino group, by chemical modification, thus eliminating the need for later deprotection. The monomer (a) and the monomer (b) thus can be copolymerized by a simpler, one-stage reaction process, leading to fewer impurities and higher yield.

The monomer (a) and the monomer (b) are cationically copolymerized preferably by a method including reacting the monomer (a) and the monomer (b) in the presence of a Lewis acid. With such a method, presumably, a cation of the monomer (b) is generated and causes cationic polymerization of the molecules of the monomer (b), while Fridel-Crafts alkylation of the monomer (a) and the monomer (b) proceeds. These reactions repeatedly occur to produce the copolymer including the structural unit (A) derived from the monomer (a) and the structural unit (B) derived from the monomer (b).

The Lewis acid is not limited. A conventionally known Lewis acid may be used. Examples thereof include aluminum chloride (AlCl₃), diethylaluminum chloride (Et₂AlCl₂), tin (IV) chloride (SnCl₄), titanium (IV) chloride (TiCl₄), boron trichloride (BCl₃), and a boron trifluoride ether complex (BF₃·EtO). Preferred among these is aluminum chloride (AlCl₃), which enables the production of the copolymer with higher yield.

More specifically, for example, when pyrogallol as the monomer (a) and α-pinene as the monomer (b) are reacted in the presence of the Lewis acid aluminum chloride (AlCl₃), the reaction shown in the scheme below is considered to proceed. Specifically, a cation of α-pinene as the monomer (b) is generated and causes cationic polymerization of molecules of α-pinene (the upper section of the scheme below), while Fridel-Crafts alkylation of pyrogallol as the monomer (a) and α-pinene as the monomer (b) proceeds (the middle section of the scheme below). These reactions repeatedly occur to produce a copolymer including a structural unit derived from pyrogallol and a structural unit derived from α-pinene (the lower section of the scheme below). Here, in such a copolymer, the structural unit derived from pyrogallol is in the backbone structure or at an end of the backbone structure.

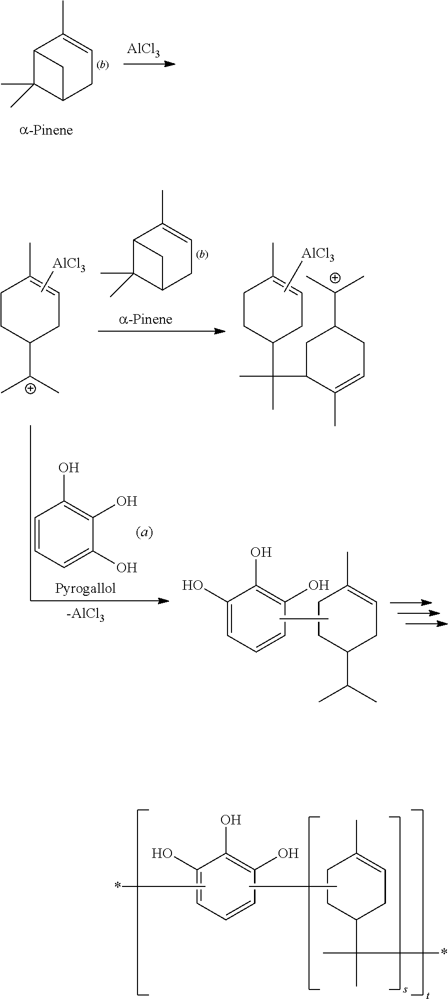

In the formula, s and t each represent an integer of 1 or greater, and * represents a linking moiety.

The tackifier resin (T1) containing the structural unit (A) in a side chain is preferably produced as follows, for example. Specifically, the tackifier resin (T1) is preferably produced by a method of copolymerizing a monomer (a′) for constituting the structural unit (A), the monomer (a′) being obtained by further introducing a unsaturated double bond to the monomer (a), and at least one monomer (b) for constituting the structural unit (B), the at least one monomer (b) being selected from the group consisting of a terpene monomer and a vinyl monomer (hereinafter this method is also referred to as the production method [II]).

Examples of the monomer (a′) include 2-vinylbenzoic acid, 3-vinylbenzoic acid, 4-vinylbenzoic acid, and 4,4′-stilbenedicarboxylic acid. Preferred among these is 4-vinylbenzoic acid, which has less steric hindrance and easily interacts with adherends. Each of these monomers (a′) may be used alone, or two or more of them may be used in combination.

Also in the production method [II] of the tackifier resin (T1), the monomer (a′) and the monomer (b) are preferably copolymerized by cationic polymerization as in the production method [I] of the tackifier resin (T1).

The monomer (a′) and the monomer (b) are cationically copolymerized preferably by a method including reacting the monomer (a′) and the monomer (b) in the presence of a Lewis acid as described above. With such a method, cationic polymerization of the unsaturated double bonds in the monomer (a′) and monomer (b) proceeds, resulting in a copolymer containing a structural unit (A) derived from the monomer (a′) and a structural unit (B) derived from the monomer (b).

The tackifier resin (T1) can enhance the adhesion of the adhesive layer (Y1) even when used in smaller amounts than conventional tackifier resins. The lower limit of the amount of the tackifier resin (T1) relative to 100 parts by mass of the base polymer (P1) is preferably 5 parts by mass, and the upper limit thereof is preferably 30 parts by mass. When the amount of the tackifier resin (T1) is 5 parts by mass or more, the adhesion of the adhesive layer (Y1), particularly adhesion to low-polarity adherends (e.g., fluororesins), can be further enhanced. When the amount of the tackifier resin (T1) is 30 parts by mass or less, a decrease in adhesion caused by excessive hardness of the adhesive layer (Y1) can be reduced. The lower limit of the amount of the tackifier resin (T1) is more preferably 10 parts by mass, and the upper limit thereof is more preferably 20 parts by mass.

The tackifier resin preferably includes at least one tackifier resin (T2) selected from the group consisting of a rosin ester resin, a terpene resin, a terpene phenol resin, and a petroleum resin. When the tackifier resin includes the tackifier resin (T2), the adhesive layer (Y1) can have higher adhesion. In particular, the tackifier resin (T2) more preferably includes at least one tackifier resin selected from the group consisting of a rosin ester resin and a terpene resin, because then the adhesion can be further enhanced. The tackifier resin (T2) still more preferably includes a rosin ester resin, because then the adhesion even to low-polarity adherends (e.g., fluororesins) can be further enhanced.

The lower limit of the softening temperature of the tackifier resin (T2) is preferably 50 °C, and the upper limit thereof is preferably 200 °C. When the softening temperature of the tackifier resin (T2) is 50 °C or higher, a decrease in adhesion caused by excessive softening of the adhesive layer (Y1) can be reduced. When the softening temperature of the tackifier resin (T2) is 200 °C or lower, the adhesive layer (Y1) can have improved interfacial wettability and be less prone to interfacial delamination. Moreover, the glass transition temperature (Tg) of the (meth)acrylic copolymer is further decreased. As a result, the later-described shear storage modulus at 25 °C of the adhesive layer (Y1) can be moderately lowered, and the flexibility of the adhesive layer (Y1) can be further improved. The adhesive layer (Y1) thus can have improved adhesion to fluororesins. The lower limit of the softening temperature of the tackifier resin (T2) is more preferably 70 °C, and the upper limit thereof is more preferably 150 °C.

The softening temperature is measured in conformity with JIS K2207 (ring and ball method).

The lower limit of the hydroxy value of the tackifier resin (T2) is preferably 0 mg KOH/g, and the upper limit thereof is preferably 200 mg KOH/g. When the hydroxy value of the tackifier resin (T2) is in the range, the adhesive layer (Y1) can have improved interfacial wettability and be less prone to interfacial delamination. The lower limit of the hydroxy value of the tackifier resin (T2) is more preferably 30 mg KOH/g, and the upper limit thereof is more preferably 130 mg KOH/g.

The hydroxy value can be measured in conformity with JIS K1557 (phthalic anhydride method).

The rosin ester resin is obtained by esterifying, with an alcohol, rosin resin mainly composed of abietic acid, disproportionated rosin resin, hydrogenated rosin resin, a dimer (polymerized rosin resin) of a resin acid (e.g., abietic acid), or the like. Some of the hydroxy groups of the alcohol used in the esterification remain unused and are incorporated in the resin, resulting in the hydroxy value adjusted to the range described above. Examples of the alcohol include polyalcohols such as ethylene glycol, glycerol, and pentaerythritol.

Examples of the rosin ester resin include Pinecrystal KE-359 (available from Arakawa Chemical Industries Ltd., hydroxy value: 40 mg KOH/g, softening temperature: 100 °C).

The terpene resin contains a structural unit derived from a monoterpene compound and contains no structural unit derived from an aromatic compound.

Examples of the terpene resin include YS Resin PX1250 (available from Yasuhara Chemical Co., Ltd., hydroxy value: 0 mg KOH/g, softening temperature: 125 °C).

The terpene phenol resin contains a structural unit derived from a monoterpene compound and a structural unit derived from a phenol compound. Herein, the “phenol compound” in the terpene phenol resin refers to a compound that contains an aromatic structure containing only one phenolic hydroxy group and contains no aromatic ring structure containing two or more phenolic hydroxy groups. The structural units (A-1) and (A-1′) described above do not correspond to the structural unit derived from a phenol compound in the terpene phenol resin.

Examples of the terpene phenol resin include YS Polyster G150 (available from Yasuhara Chemical Co., Ltd., hydroxy value: 120 mg KOH/g, softening temperature: 150 °C).

Examples of the petroleum resin include ARKON P-140 (available from Arakawa Chemical Industries Ltd., hydroxy value: 0 mg KOH/g, softening temperature: 140 °C).

The lower limit of the amount of the tackifier resin (T2) relative to 100 parts by mass of the base polymer (P1) is preferably 10 parts by mass, and the upper limit thereof is preferably 100 parts by mass. When the amount of the tackifier resin (T2) is 10 parts by mass or more, the adhesive layer (Y1) can have higher adhesion. When the amount of the tackifier resin (T2) is 100 parts by mass or less, a decrease in adhesion caused by excessive hardness of the adhesive layer (Y1) can be reduced. The lower limit of the amount of the tackifier resin (T2) is more preferably 15 parts by mass, and the upper limit thereof is more preferably 60 parts by mass, still more preferably 50 parts by mass, further more preferably 40 parts by mass.

When the base polymer (P1) includes a (meth)acrylic copolymer, the adhesive layer (Y1) preferably further contains a curing agent. The curing agent contained in the adhesive layer (Y1) allows the (meth)acrylic copolymer to form a chemically crosslinked structure, which further improves the bulk cohesion of the adhesive layer (Y1) and also increases the later-described gel fraction of the adhesive layer (Y1), leading to further improved adhesion of the resulting adhesive sheet.

Examples of the curing agent include isocyanate curing agents, aziridine curing agents, epoxy curing agents, and metal chelate curing agents. In particular, the curing agent preferably contains an isocyanate curing agent to allow moderate chemical crosslinking of the (meth)acrylic copolymer and further improve the adhesion of the adhesive layer (Y1).

Examples of the isocyanate curing agent include Coronate L-45 (available from Tosoh Corporation), Takenate 500 (available from Mitsui Chemicals, Inc.), and Desmodur L-75 (available from Covestro).

The lower limit of the amount of the curing agent relative to 100 parts by mass of the (meth)acrylic copolymer is preferably 0.01 parts by mass, and the upper limit thereof is preferably 20 parts by mass. When the amount of the curing agent is in the range, the (meth)acrylic copolymer can be chemically crosslinked moderately, and the adhesion of the resulting adhesive sheet can be further improved. The lower limit of the amount of the curing agent is more preferably 0.1 parts by mass, and the upper limit is more preferably 10.0 parts by mass. The lower limit is still more preferably 0.5 parts by mass, and the upper limit is still more preferably 8.0 parts by mass.

When the base polymer (P1) includes a silicone resin, the adhesive layer (Y1) preferably further contains a catalyst. The catalyst contained in the adhesive layer (Y1) allows the silicone resin to form a moderately crosslinked structure, which further improves the bulk cohesion of the adhesive layer (Y1) and also increases the later-described gel fraction of the adhesive layer (Y1), leading to further improved adhesion of the adhesive layer (Y1).

Examples of the catalyst include platinum catalysts and benzoyl peroxide. In particular, the catalyst preferably includes a platinum catalyst from the standpoint of reducing odor and from the standpoint of the tear strength and compression set of the adhesive layer (Y1).

Examples of the platinum catalyst include CAT-PL-50T (available from Shin-Etsu Chemical Co., Ltd.).

The lower limit of the amount of the catalyst relative to 100 parts by mass of the silicone resin is preferably 0.01 parts by mass, and the upper limit thereof is preferably 5.0 parts by mass. When the amount of the catalyst is in the range, the silicone resin can be crosslinked moderately, and the adhesion of the adhesive layer (Y1) can be further improved. The lower limit of the amount of the catalyst is more preferably 0.1 parts by mass, and the upper limit is more preferably 3.0 parts by mass. The lower limit is still more preferably 0.2 parts by mass, and the upper limit is still more preferably 2.0 parts by mass.

The adhesive layer (Y1) may further contain a colorant to impart light shielding properties. Examples of the colorant include carbon black, aniline black, and titanium oxide. Preferred among these is carbon black, which is relatively inexpensive and chemically stable.

The adhesive layer (Y1) may contain conventionally known fine particles and additives such as inorganic fine particles, conductive fine particles, antioxidants, foaming agents, organic fillers, or inorganic fillers, if necessary.

The adhesive layer (Y1) preferably has a loss tangent (tan δ) that has a peak in the temperature range from −30 °C to 15 °C as measured by dynamic viscoelasticity measurement at a frequency of 10 Hz (hereinafter the loss tangent is also referred to as “the loss tangent of the adhesive layer (Y1) as measured at a frequency of 10 Hz”). When the loss tangent (tan δ) of the adhesive layer (Y1) as measured at a frequency of 10 Hz has a peak in a temperature range of −30 °C or higher, the adhesive layer (Y1) can have further improved adhesion to fluororesins. When the loss tangent (tan δ) of the adhesive layer (Y1) as measured at a frequency of 10 Hz has a peak in a temperature range of 15 °C or lower, the zipping phenomena in removing a protecting film of the adhesive layer of the adhesive sheet can be reduced, preventing a loss of adhesion of the resulting adhesive sheet before use.

The lower limit of the temperature at which the loss tangent of the adhesive layer (Y1) as measured at a frequency of 10 Hz shows the peak (hereinafter also simply referred to as “the loss tangent peak temperature”) is more preferably-25 °C, and the upper limit thereof is more preferably 13 °C. The lower limit is still more preferably-20 °C, and the upper limit is still more preferably 11 °C.

The lower limit of the shear storage modulus at 25 °C of the adhesive layer (Y1) as measured by dynamic viscoelasticity measurement at a frequency of 10 Hz is preferably 1.0×10⁴ Pa, and the upper limit thereof is preferably 5.0×10⁵ Pa. When the shear storage modulus at 25 °C of the adhesive layer (Y1) is in the range, the resulting adhesive sheet can have better adhesion. Moreover, the adhesive layer (Y1) can have excellent flexibility and further improved adhesion to fluororesins. The lower limit of the shear storage modulus at 25 °C of the adhesive layer (Y1) is more preferably 3.0×10⁴ Pa, and the upper limit thereof is more preferably 4.0×10⁵ Pa. The lower limit is still more preferably 5.0×10⁴ Pa, and the upper limit is still more preferably 3.5×10⁵ Pa.

The peak temperature of the loss tangent of the adhesive layer (Y1) at a frequency of 10 Hz and the shear storage modulus at 25 °C of the adhesive layer (Y1) can be measured by dynamic viscoelasticity measurement.

Specifically, the shear storage modulus of the adhesive layer (Y1) can be measured, for example, by stacking multiple adhesive layers to a thickness of 1 mm to prepare a measurement sample consisting only of the adhesive layers, and subjecting the measurement sample to measurement of a dynamic viscoelastic spectrum from −50 °C to 200 °C using a viscoelastic spectrometer (e.g., DVA-200 available from IT Keisoku Seigyo Co., Ltd.) in a shear mode at a temperature increase rate of 5 °C/min and a measurement frequency of 10 Hz. Further, from the dynamic viscoelastic spectrum obtained at this time, the loss tangent peak temperature of the adhesive layer (Y1) can be obtained.

The peak temperature of the loss tangent (tan δ) of the adhesive layer (Y1) as measured at a frequency of 10 Hz and the shear storage modulus at 25 °C of the adhesive layer (Y1) can be adjusted by, for example, adjusting the types or proportions of the monomers constituting the (meth)acrylic copolymer, the weight average molecular weight of the (meth)acrylic copolymer, the presence or absence of the tackifier resin (T2), the types or proportions of the tackifier resin (T1) and the tackifier resin (T2), or the gel fraction of the adhesive layer (Y1) described below.

The lower limit of the gel fraction of the adhesive layer (Y1) is preferably 0% by mass, and the upper limit thereof is preferably 99% by mass. When the gel fraction of the adhesive layer (Y1) is 0% by mass or greater, the adhesive layer (Y1) can have increased bulk strength, and the resulting adhesive sheet can have better adhesion. Moreover, when the gel fraction of the adhesive layer (Y1) is 99% by mass or less, the above-described shear storage modulus at 25 °C of the adhesive layer (Y1) can be moderately lowered, and the adhesive layer (Y1) can be further improved flexibility and improved adhesion to fluororesins. The adhesive layer (Y1) can more closely adhere to the substrate. The lower limit of the gel fraction of the adhesive layer (Y1) is more preferably 10% by mass, and the upper limit thereof is more preferably 60% by mass. The lower limit is still more preferably 25% by mass, and the upper limit is still more preferably 50% by mass.

The gel fraction of the adhesive layer (Y1) can be measured by the following method, for example.

The adhesive sheet is cut into a flat rectangular shape with a size of 50 mm in width×100 mm in length to prepare a specimen. The specimen is immersed in an organic solvent at 23 °C for 24 hours, then taken out of the organic solvent, and dried at 110 °C for 1 hour. The organic solvent may be ethyl acetate, for example, when the base polymer (P1) is a (meth)acrylic copolymer. The organic solvent may be toluene, for example, when the base polymer (P1) is a styrene elastomer or a silicon resin. The mass of the dried specimen is measured, and the gel fraction is calculated using the following equation (2). No release film for protecting the adhesive layer (Y1) was stacked on the specimen. When the adhesive sheet includes no substrate, the calculation is performed with W₀=0.

Gel fraction (% by mass)=100×(W₂−W₀)/(W₁−W₀) (2)

(W₀: mass of substrate, W₁: mass of specimen before immersion, W₂: mass of specimen after immersion and drying)

The gel fraction of the adhesive layer (Y1) can be adjusted to the above range by, for example, adjusting the types or proportions of the monomers constituting the (meth)acrylic copolymer, the weight average molecular weight of the (meth)acrylic copolymer, or the type or proportion of the curing agent.

The lower limit of the thickness of the adhesive layer (Y1) is preferably 25 μm, and the upper limit thereof is preferably 1,000 μm. When the thickness of the adhesive layer (Y1) is within the range, the adhesive layer (Y1) can have sufficient adhesion. The lower limit of the thickness of the adhesive layer (Y1) is more preferably 50 μm, and the upper limit thereof is more preferably 500 μm. The lower limit is still more preferably 100 μm, and the upper limit is still more preferably 300 μm.

The adhesive sheet of the present invention may include other layer(s) than the substrate and the adhesive layer (Y1), as necessary.

The adhesive sheet of the present invention preferably further includes an adhesive layer (Y2) on another surface of the substrate. When the adhesive sheet of the present invention includes the adhesive layer (Y2) on the other surface of the substrate, fluororesin and a different component can be bonded simultaneously.

To make the adhesive sheet reversible and provide good handleability, the adhesive layer (Y2) is preferably the same as the adhesive layer (Y1) described above. When the adhesive layer (Y2) is different from the adhesive layer (Y1), the adhesive layer (Y2) is preferably a low-tack adhesive layer from the standpoint of workability during attachment. When the adhesive layer (Y2) is a low-tack adhesive layer, the stickiness of the adhesive layer (Y2) can be reduced, so that the resulting adhesive sheet can have better workability during attachment.

The upper limit of the probe tack value of the adhesive layer (Y2) as measured at 23 °C, a pressuring pressure of 98 gf, a pressuring speed of 100 mm/sec, a pressuring time of 10 seconds, and a withdrawal speed of 5 mm/sec (hereinafter also referred to as “the probe tack value at 23 °C of the adhesive layer (Y2)”) is preferably 2,000 gf/5 mmo. When the probe tack value at 23 °C of the adhesive layer (Y2) is 2,000 gf/5 mmo or less, the stickiness of the adhesive layer (Y2) can be reduced, so that the resulting adhesive sheet can have better workability during attachment. The upper limit of the probe tack value at 23 °C of the adhesive layer (Y2) is more preferably 1,500 gf/5 mmφ, still more preferably 1,000 gf/5 mmφ.

The lower limit of the probe tack value at 23 °C of the adhesive layer (Y2) is preferably 1.0 gf/5 mmφ. When the probe tack value at 23 °C of the adhesive layer (Y2) is 1.0 gf/5 mmφ or greater, the adhesive layer (Y2) can have moderate adhesion, which makes it easier to adjust the attachment position of the adhesive sheet of the present invention, leading to better workability during attachment. The lower limit of the probe tack value at 23 °C of the adhesive layer (Y2) is more preferably 10 gf/5 mm, still more preferably 100 gf/5 mmφ.

The probe tack value at 23 °C of the adhesive layer (Y2) can be measured by a probe tack test in conformity with JIS Z3284.

Specifically, for example, the adhesive sheet of the present invention is cut into a specimen with a size of 30 mm in width×30 mm in length. The probe tack test is performed on the adhesive layer (Y2) of the specimen using a probe tack tester (e.g., TAC-2 available from RHESCA) at 23 °C, a pressuring pressure of 98 gf, a pressuring speed of 100 mm/sec, a pressuring time of 10 seconds, and a withdrawal speed of 5 mm/sec, whereby the probe tack value can be measured.

The probe tack value at 23 °C of the adhesive layer (Y2) can be adjusted, for example, by a method of changing the composition or proportion of the base polymer (P2) or tackifier resin (T3) to be contained in the adhesive layer (Y2), or a method of changing the thickness of the adhesive layer (Y2).

The lower limit of the 180° peeling force at 23 °C of the adhesive layer (Y2) for SUS when the adhesive layer (Y2) is pressured-bonded by pressurization at 0.1 MPa for 10 minutes in an environment at 150 °C (hereinafter also simply referred to as “the 180° peeling force at 23 °C of the adhesive layer (Y2) after heating for SUS”) is preferably 10 N/25 mm. When the 180° peeling force at 23 °C of the adhesive layer (Y2) after heating for SUS is 10 N/25 mm or greater, the adhesive sheet can exhibit excellent adhesion when heated, and thus can achieve both excellent workability during attachment and excellent adhesion. The lower limit of the 180° peeling force at 23 °C of the adhesive layer (Y2) after heating for SUS is preferably 15 N/25 mm, more preferably 20 N/25 mm.

There is no particular upper limit for the 180° peeling force at 23 °C of the adhesive layer (Y2) after heating for SUS, but from the standpoint of close adhesion to PTFE sheets, the upper limit is preferably 500 N/25 mm, more preferably 400 N/25 mm, still more preferably 300 N/25 mm.

The 180° peeling force at 23 °C of the adhesive layer (Y2) after heating for SUS can be measured by the following method, for example.

Specifically, the adhesive sheet is cut into a size of 25 mm in width×100 mm in length, and then the adhesive layer (Y1) is backed with a 2-mm-thick polytetrafluoroethylene sheet (Yodoflon, available from Yodogawa Hu-Tech Co., Ltd.). The adhesive sheet is then pressure-bonded to a SUS plate (SUS304 plate washed with ethanol and then wiped dry) by pressurization at 0.1 MPa for 10 minutes in an environment at 150 °C. The workpiece is then air-cooled to prepare a test sample. The obtained test sample is subjected to a 180° peel test in conformity with JIS Z0237 using a tensile tester (e.g., Tensilon, available from Orientec) at 23 °C, 50% RH, and a peel rate of 300 mm/min. The adhesive sheet is peeled off from the SUS plate, whereby the 180° peeling force at 23 °C of the adhesive layer (Y2) for SUS can be measured.

The 180° peeling force at 23 °C of the adhesive layer (Y2) after heating for SUS may be adjusted, for example, by a method of changing the composition of the base polymer (P2) to be contained in the adhesive layer (Y2) or a method of changing the thickness of the adhesive layer (Y2).

The adhesive layer (Y2) preferably contains a base polymer (P2).

The base polymer (P2) preferably includes at least one selected from the group consisting of a (meth)acrylic copolymer, a styrene elastomer, an ethylene-vinyl acetate copolymer, a chloroprene rubber, a nitrile rubber, a polyurethane resin, a polyamide resin, a polyolefin resin, a polyester resin, an epoxy resin, and a silicone resin. In particular, to facilitate adjustment of the probe tack value or improve the heat resistance, the base polymer (P2) preferably includes at least one selected from the group consisting of a (meth)acrylic copolymer, a styrene elastomer, a chloroprene rubber, a nitrile rubber, a polyurethane resin, a polyamide resin, a polyolefin resin, and a polyester resin.

The (meth)acrylic copolymer, styrene elastomer, and silicone resin in the base polymer (P2) may be the same as those in the base polymer (P1) described above.

Specific examples of the (meth)acrylic copolymer in the base polymer (P2) include SK-Dyne 1717DT and SK1986DT (both available from Soken Chemical & Engineering Co., Ltd.).

Examples of the ethylene-vinyl acetate copolymer include HM200 (available from Cemedine Co., Ltd.).

Examples of the chloroprene rubber include 575F (available from Cemedine Co., Ltd.) and G17 (available from Konishi Co., Ltd.).

Examples of the nitrile rubber include 501F (available from Cemedine Co., Ltd.).

Examples of the polyurethane resin include SHM107-PUR (available from Sheedom Co., Ltd.)

Examples of the polyamide include SHM301-PAD (Sheedom Co., Ltd.).

Examples of the polyolefin resin include PPET1200F (available from Toagosei Co., Ltd.).

Examples of the polyester resin include PH-413 (available from Nihon Matai Co., Ltd.).

Examples of the epoxy resin include 1500 (available from Cemedine Co., Ltd.).

The adhesive layer (Y2) preferably further contains a tackifier resin (T3) to further improve the adhesion. Examples of the tackifier resin (T3) include the same tackifier resins as the tackifier resin (T1) and the tackifier resin (T2).

When the base polymer (P2) includes the (meth)acrylic copolymer, the adhesive layer (Y2) preferably further contains a curing agent. The curing agent contained in the adhesive layer (Y2) allows the (meth)acrylic copolymer to form a chemically crosslinked structure, which can further improve the adhesion of the resulting adhesive sheet.

The curing agent contained in the adhesive layer (Y2) may be the same as that contained in the adhesive layer (Y1), for example.

The adhesive layer (Y2) may contain conventionally known fine particles and additives such as inorganic fine particles, conductive fine particles, antioxidants, foaming agents, organic fillers, or inorganic fillers, if necessary.

The lower limit of the thickness of the adhesive layer (Y2) is preferably 20 μm, and the upper limit thereof is preferably 1,000 μm. When the thickness of the adhesive layer (Y2) is in the range, the adhesive layer (Y2) can have sufficient adhesion. The lower limit of the thickness of the adhesive layer (Y2) is more preferably 25 μm. The upper limit thereof is more preferably 500 μm, still more preferably 300 μm.

The method for producing the adhesive sheet of the present invention is not limited. For example, it may be produced using the following method.

First, a solvent is added to materials such as the base polymer (P1), the tackifier resin(s), and if necessary the curing agent to prepare an adhesive solution (a). This adhesive solution (a) is applied to the release-treated surface of a PET release film, and the solvent in the solution is completely removed by drying, whereby a laminate film including an adhesive layer (Y1) is prepared. The laminate film prepared is placed on the substrate such that the adhesive layer (Y1) faces the substrate, and the workpiece is aged for 48 hours in an environment at 40 °C and 50% RH, whereby an adhesive sheet can be obtained that includes the substrate and the adhesive layer (Y1) on one surface of the substrate. The step of applying the adhesive solution (a) to the release-treated surface of the PET release film may be completed in one time, or may be performed multiple times by applying in such a manner that the adhesive solution is applied to the previously formed layer of the adhesive solution. The thickness of the adhesive layer (Y1) can be easily adjusted by adjusting the number of times of performing the application step. Separately, an adhesive solution (b) is prepared in the same manner. This adhesive solution (b) is applied to the release-treated surface of a PET release film, and the solvent in the solution is completely removed by drying, whereby a different laminate film including an adhesive layer (Y2) is prepared. The step of applying the adhesive solution (b) to the release-treated surface of the PET release film may be performed one time, or may be performed multiple times by applying in such a manner that the adhesive solution is applied to the previously formed layer of the adhesive solution. The thickness of the adhesive layer (Y2) can be easily adjusted by adjusting the number of times of performing the application step.

The different laminate film prepared is placed on the substrate such that the adhesive layer (Y2) faces the surface of the substrate that is not provided with the adhesive layer (Y1). The workpiece is aged for 48 hours in an environment at 40 °C and 50% RH, whereby an adhesive sheet can be obtained that includes the substrate, the adhesive layer (Y1) on one surface of the substrate, and the adhesive layer (Y2) on the other surface of the substrate.

The adhesive sheet of the present invention can be used in any applications. Since the adhesive sheet has excellent adhesion to fluororesins such as polytetrafluoroethylene without any pretreatment on the fluororesins, the adhesive sheet is suitably used for bonding fluororesin to a different type of component for various purposes. Specific examples of various purposes include sliding enhancement on friction surfaces, prevention of wear of sliding parts, insulation covering, and protection of adherends from high temperature, chemical liquids, or the like. In particular, the adhesive sheet is suitably used for protection of adherends, particularly protection of adherends from chemical liquids. Further, since the adhesive sheet of the present invention can reduce peeling of the substrate and achieve highly strong adhesion, the adhesive sheet is more suitably used in bonding a lining sheet to the tank body of a chemical tank for a semiconductor or a chemical tank for a chemical industry.

The present invention also encompasses a chemical tank including a tank body and the adhesive sheet of the present invention attached to an inner surface of the tank body. In the chemical tank including the adhesive sheet of the present invention attached to the inner surface of the tank body, fluororesin can be firmly bonded to the inner surface of the tank body via the adhesive layer (Y1) of the attached adhesive sheet of the present invention. Thus, the chemical tank can further reduce peeling or lifting of the fluororesin caused by the chemical solution stored in the chemical tank to which the fluororesin is bonded.

The present invention also encompasses a laminate sheet including the adhesive sheet of the present invention and a fluororesin-containing sheet on a surface of the adhesive layer (Y1), the surface being different from a surface in contact with the substrate.

The laminate sheet of the present invention includes a fluororesin-containing sheet. The laminate sheet of the present invention thus further facilitates fluororesin bonding for various purposes.

Examples of the fluororesin-containing sheet in the laminate sheet of the present invention include sheets containing polytetrafluoroethylene (PTFE), sheets containing perfluoroalkoxy alkanes (PFA), sheets containing perfluoroethylenepropene copolymers (FEP), sheets containing ethylenetetrafluoroethylene copolymers (ETFE), sheets containing polyvinylidene fluoride (PVDF), sheets containing polyvinyl fluoride (PVF), sheets containing polychlorotrifluoroethylene (PCTFE), and sheets containing ethylenechlorotrifluoroethylene copolymers (ECTFE). In particular, sheets containing PTFE are preferred because they have excellent heat resistance and excellent chemical resistance.

The laminate sheet of the present invention can be used in any applications. The laminate can be suitably used for bonding fluororesin to a different type of component for various purposes. Specific examples of various purposes include sliding enhancement on friction surfaces, prevention of wear of sliding parts, insulation covering, and protection of adherends from high temperature, chemical liquids, or the like. In particular, the laminate sheet is suitably used for protection of adherends, particularly protection of adherends from chemical liquids. Examples of adherends to be protected from chemical liquids include, but are not limited to, tank bodies, trays, and walls. Specifically, the laminate sheet can be suitably used as a covering material for chemical tanks for semiconductors, chemical tanks for chemical industries, or piping for chemical liquid transportation, a covering material for electronic device components, or a building material. In particular, the laminate sheet of the present invention is more suitably used for lining of a tank body (surface treatment to cover an inner surface of a tank body) of a chemical tank for a semiconductor or of a chemical tank for a chemical industry.

The present invention also encompasses a chemical tank including a tank body and the laminate sheet of the present invention attached to an inner surface of the tank body.

The present invention also encompasses a method for producing a chemical tank for a semiconductor or a chemical tank for a chemical industry, the method including a step of attaching the laminate sheet of the present invention to an inner surface of a tank body of a chemical tank.

The present invention also encompasses a method for producing a chemical tank for a semiconductor or a chemical tank for a chemical industry, the method including a step of producing a laminate sheet by pressure-bonding a fluororesin-containing sheet to the adhesive layer (Y1) of the adhesive sheet of the present invention, the adhesive sheet of the present invention including the adhesive layer (Y2) on the other surface of the substrate; and a step of attaching the adhesive layer (Y2) of the laminate sheet to an inner surface of a tank body of a chemical tank.

Examples of the fluororesin-containing sheet in the step of producing the laminate sheet include sheets containing polytetrafluoroethylene (PTFE), sheets containing perfluoroalkoxy alkanes (PFA), sheets containing perfluoroethylenepropene copolymers (FEP), sheets containing ethylenetetrafluoroethylene copolymers (ETFE), sheets containing polyvinylidene fluoride (PVDF), sheets containing polyvinyl fluoride (PVF), sheets containing polychlorotrifluoroethylene (PCTFE), and sheets containing ethylenechlorotrifluoroethylene copolymers (ECTFE). In particular, sheets containing PTFE are preferred because they have excellent heat resistance and excellent chemical resistance.

### Advantageous Effects of Invention

The present invention can provide an adhesive sheet that, on one surface, has excellent adhesion to fluororesins such as polytetrafluoroethylene without requiring any pretreatment on the fluororesins and, on the other surface, is capable of suppressing peeling of the substrate. The present invention can also provide a laminate sheet including the adhesive sheet. The present invention can also enable production of a chemical tank to which the adhesive sheet or the laminate sheet is attached. The present invention can also provide a method for producing a chemical tank using the laminate sheet or the adhesive sheet.

### DESCRIPTION OF EMBODIMENTS

The embodiments of the present invention are more specifically described in the following with reference to examples.

### (Preparation of Acrylic Copolymer)

### Synthesis Example 1

A reactor equipped with a thermometer, a stirrer, and a condenser was charged with 100 parts by mass of ethyl acetate, purged with nitrogen, and then heated to start reflux. Thirty minutes after the ethyl acetate came to a boil, 0.08 parts by mass of azobisisobutyronitrile as a polymerization initiator was added. The monomer mixture of the structural unit monomers shown in Table 1 was then uniformly and gradually dropped to the mixture over 1.5 hours for reaction. Thirty minutes after the termination of dropping, 0.1 parts by mass of azobisisobutyronitrile was added to continue the polymerization reaction for an additional 5 hours.

The contents of the reactor were then cooled while being diluted by adding ethyl acetate into the reactor, whereby an acrylic copolymer solution having a solid content of 25% by mass was obtained. The obtained acrylic copolymer solution was passed through a filter (material: polytetrafluoroethylene, pore size: 0.2 μm). The obtained filtrate was supplied to a gel permeation chromatograph (2690 Separations Module, available from Waters) and subjected to GPC measurement at a sample flow rate of 1 mL/min and a column temperature of 40 °C. The molecular weight of the acrylic copolymer in terms of polystyrene was measured, and the weight average molecular weight (Mw) and the molecular weight distribution (Mw/Mn) were determined. The column used was GPC KF-806L (available from Showa Denko K.K.). The detector used was a differential refractometer. Table 1 shows the results.

### Synthesis Examples 2 and 3

An acrylic copolymer was obtained as in Example 1 except that the monomer mixture was changed as shown in Table 1. Table 1 shows the results.

The structural unit monomers shown in Table 1 are as follows.
BA: n-butyl acrylate
2EHA: 2-ethylhexyl acrylate
LA: lauryl acrylate
HEA: 2-hydroxyethyl acrylate
AAc: acrylic acid

TABLE 1

| | | Synthesis Example | | |
|---|---|---|---|---|
| Acrylic copolymer | | 1 | 2 | 3 |
| Structural unit monomer | BA | 96.9 | — | — |
| (parts by mass) | 2EHA | — | 96.9 | 86.9 |
| | LA | — | — | 10 |
| | HEA | 0.1 | 0.1 | 0.1 |
| | AAc | 3 | 3 | 3 |

| | | | |
|---|---|---|---|
| Weight average molecular weight (Mw) | 1000000 | 900000 | 950000 |
| Molecular weight distribution (Mw/Mn) | 3.8 | 4.5 | 4.7 |

### (Preparation of Tackifier Resin (T1) or Tackifier Resin (T3))

### Synthesis Example A

A reactor equipped with a thermometer, a stirrer, and a condenser was charged with 50 parts by mass of toluene, purged with nitrogen, and then heated to start reflux. After 30 minutes, while the toluene was kept at 75 °C, 2 parts by mass of aluminum chloride (AlCl₃) was added. Then, a solution of a total of 50 parts by mass of catechol (pyrocatechol) (n=2) and α-pinene (the molar ratio was as shown in Table 2) in 50 parts by mass of toluene was gradually dropped to the mixture over 1.5 hours for reaction. After 4 hours of polymerization reaction, the contents of the reactor were cooled while 0.1 parts by mass of pyridine was added into the reactor to neutralize hydrochloric acid produced from aluminum chloride (AlCl₃). The precipitate resulting from neutralization was filtered out, and the obtained filtrate was subjected to liquid separation. Toluene was then evaporated off, whereby a solid tackifier resin (T1) or tackifier resin (T3) was obtained.

¹H-NMR measurement of the obtained tackifier resin (T1) or tackifier resin (T3) showed that the tackifier resin (T1) was a copolymer containing a structural unit (A) derived from catechol (pyrocatechol) and a structural unit (B) derived from α-pinene (copolymer containing a structural unit (A) in the backbone structure or an end of the backbone structure).

A solution of the tackifier resin (T1) or tackifier resin (T3) in tetrahydrofuran was passed through a filter (material: polytetrafluoroethylene, pore size: 0.2 μm). The obtained filtrate was supplied to a gel permeation chromatograph (2690 Separations Module, available from Waters) and subjected to GPC measurement at a sample flow rate of 1 mL/min and a column temperature of 40 °C. The molecular weight of the tackifier resin (T1) or tackifier resin (T3) in terms of polystyrene was measured to determine the weight average molecular weight (Mw). The column used was GPC KF-802.5L (available from Showa Denko K.K.). The detector used was a differential refractometer. Table 2 shows the results.

### (Measurement of Bio-Derived Carbon Content in Tackifier Resin (T1) or Tackifier Resin (T3))

The bio-derived carbon content of the obtained tackifier resin (T1) or tackifier resin (T3) was measured in conformity with ASTM D6866-22. Table 2 shows the results.

### Synthesis Examples B to C and E

A tackifier resin (T1) or tackifier resin (T3) was synthesized and subjected to measurements as in Synthesis Example A except that the monomers were changed as shown in Table 2 in (Preparation of tackifier resin (T1) or tackifier resin (T3)) described above. Table 2 shows the results.

### Synthesis Example D

### (Preparation of Tackifier Resin (T1) or Tackifier Resin (T3))

A reactor equipped with a thermometer, a stirrer, and a condenser was charged with 50 parts by mass of toluene, purged with nitrogen, and then heated to start reflux. After 30 minutes, while the toluene was kept at 75 °C, 2 parts by mass of aluminum chloride (AlCl₃) was added. Then, a solution of a total of 70 parts by mass of 4-vinyl benzoic acid (m=1) and α-pinene (the molar ratio was as shown in Table 2) in 50 parts by mass of toluene was gradually dropped to the mixture over 1.5 hours for reaction. After 4 hours of polymerization reaction, the contents of the reactor were cooled while 0.1 parts by mass of pyridine was added into the reactor to neutralize hydrochloric acid produced from aluminum chloride (AlCl₃). The precipitate resulting from neutralization was filtered out, and the obtained filtrate was subjected to liquid separation. Toluene was then evaporated off, whereby a solid tackifier resin (T1) or tackifier resin (T3) was obtained.

¹H-NMR measurement of the obtained tackifier resin (T1) or tackifier resin (T3) showed that the tackifier resin (T1) or tackifier resin (T3) was a copolymer containing a structural unit (A) derived from 4-vinyl benzoic acid and a structural unit (B) derived from α-pinene (copolymer containing a structural unit (A) in a side chain).

A solution of the tackifier resin (T1) or tackifier resin (T3) in tetrahydrofuran was passed through a filter (material: polytetrafluoroethylene, pore size: 0.2 μm). The obtained filtrate was supplied to a gel permeation chromatograph (2690 Separations Module, available from Waters) and subjected to GPC measurement at a sample flow rate of 1 mL/min and a column temperature of 40 °C. The molecular weight of the tackifier resin (T1) or tackifier resin (T3) in terms of polystyrene was measured to determine the weight average molecular weight (Mw). The column used was GPC KF-802.5L (available from Showa Denko K.K.). The detector used was a differential refractometer. Table 2 shows the results.

### (Measurement of Bio-Derived Carbon Content in Tackifier Resin (T1) or Tackifier Resin (T3))

The bio-derived carbon content of the obtained tackifier resin (T1) or tackifier resin (T3) was measured in conformity with ASTM D6866-22. Table 2 shows the results.

TABLE 2

| | | | Synthesis Example | | | | |
|---|---|---|---|---|---|---|---|
| Tackifier resin (T1) or tackifier resin (T3) | | | A | B | C | D | E |
| Structural unit | Structural unit | Catechol (n = 2) | 10 | — | — | — | — |
| monomer | (A) | Pyrogallol (n = 3) | — | 10 | 10 | — | — |
| (mol %) | | 4-Vinylbenzoic acid (m = 1) | — | — | — | 10 | — |
| | | 1,2,3-Trimethoxybenzene (l = 3) | — | — | — | — | 10 |
| | Structural unit | α-Pinene | 90 | 90 | 80 | 90 | 90 |
| | (B) | Styrene | — | — | 10 | — | — |

| | | | | | |
|---|---|---|---|---|---|
| Weight average molecular weight (Mw) | 770 | 560 | 900 | 800 | 810 |
| Structural unit (A) content (% by mass) | 8.2 | 9.3 | 9.6 | 10.8 | 12.1 |
| Bio-derived carbon content (% by mass) | 90 | 100 | 90 | 90 | 90 |

### Example 1

### (1) Preparation of Adhesive Sheet

Ten parts by mass of a tackifier resin (T1) (Synthesis Example A) was added to 100 parts by mass of the solids of an acrylic copolymer (Synthesis Example 1). Further, 30 parts by mass of ethyl acetate (available from Fuji Chemicals Ltd.) and 0.5 parts by mass of an isocyanate curing agent (Desmodur L-75, available from Covestro) were added and sufficiently stirred, whereby an adhesive solution (a) was obtained.

The adhesive solution (a) was applied to the release-treated surface of a 75-μm-thick PET release film (SP3000, available from Toyo Cloth Co., Ltd.) and dried at 100 °C for five minutes, whereby a laminate film including a 50-μm-thick adhesive layer (Y1) was obtained. A 60-μm-thick non-woven fabric (G2260-1S, available from Toray International, Inc.) was provided as a substrate. The laminate film prepared was placed on the substrate such that the adhesive layer (Y1) faced the substrate, followed by heating at 40 °C for 48 hours for aging. This produced an adhesive sheet including the substrate and the adhesive layer (Y1) on one surface of the substrate.

### (2) Measurement of 180° Peeling Force at 23 °C of Adhesive Layer (Y1) for Polytetrafluoroethylene

The obtained adhesive sheet was cut into a size of 25 mm in width×100 mm in length, and then the adhesive layer (Y1) surface was pressure-bonded to a 2-mm-thick polytetrafluoroethylene sheet (Yodoflon, available from Yodogawa Hu-Tech Co., Ltd.) by moving a 2-kg rubber roller back and forth once thereon at a speed of 300 mm/min. The workpiece was left to stand for aging in an environment at 23 °C and 50% RH for 20 minutes, whereby a test sample was prepared. The obtained test sample was subjected to a 180° peel test in conformity with JIS Z0237 using a tensile tester (Tensilon, available from Orientec) at 23 °C, 50% RH, and a peel rate of 300 mm/min. The adhesive layer (Y1) was peeled off from the polytetrafluoroethylene film, whereby the 180° peeling force at 23 °C of the adhesive layer (Y1) for polytetrafluoroethylene was measured. Table 3 shows the results.

### (3) Measurement of Heat Shrinkage of Substrate

The substrate shown in Table 3 was cut into a 10-cm square specimen. The specimen was placed in an oven at 120 °C and heated for 10 minutes. The heated specimen was air-cooled to room temperature, and then the length of the specimen was measured. The heat shrinkage of the substrate was determined using the following equation (1). Here, “Length of one side of specimen before heating” and “Length of one side of specimen after heating” refer to the length of the same side. Table 3 shows the results.

Heat shrinkage (%)=((Length of one side of specimen before heating)−(Length of one side of specimen after heating))/(Length of one side of specimen before heating)×100 (1)

### Examples 2 to 14 and Comparative Examples 1 to 7

An adhesive sheet was prepared and subjected to measurements as in Example 1 except that in (1) Preparation of adhesive sheet described above, the composition and thickness of the adhesive layer (Y1) and the type and thickness of the substrate were changed as shown in Tables 3 and 5. Tables 3 and 5 show the results. The open-cell polyurethane foam PORON used in Example 14 was PORON SR-S-70P.

### Examples 15 to 18 and 21 to 23 and Comparative Examples 8 and 9

### (1) Preparation of Adhesive Sheet

A laminate film including an adhesive layer (Y1) with the composition and thickness shown in Table 4 or 6 was obtained as in Example 1. An adhesive solution (b) with the composition shown in Table 4 or 6 was prepared as in Example 1. The adhesive solution (b) was applied to the release-treated surface of a 75-μm-thick PET release film (SP3000, available from Toyo Cloth Co., Ltd.) and dried at 100 °C for five minutes, whereby a laminate film including a 50-μm-thick adhesive layer (Y2) was obtained. The laminate films were placed on the substrate shown in Table 4 or 6 such that the adhesive layer (Y1) of one laminate film faced one surface of the substrate and the adhesive layer (Y2) of the other laminate film faced a second surface of the substrate. The workpiece was heated at 40 °C for 48 hours for aging. This produced an adhesive sheet including the substrate, the adhesive layer (Y1) on one surface of the substrate, and the adhesive layer (Y2) on the othersurface of the substrate.

In Examples 15 to 18 and Comparative Examples 8 and 9, although the adhesive layers placed on the two surfaces of the substrate were the same and unable to be distinguished as the adhesive layer (Y1) or the adhesive layer (Y2), the adhesive layer as the subject of Measurement of 180° peeling force for polytetrafluoroethylene described above was designated as the adhesive layer (Y1), while the adhesive layer as the subject of Measurement of 180° peeling force for SUS, described later in Evaluation, was designated as the adhesive layer (Y2). In Examples 15 to 18, the subject of (4) Measurement of probe tack value at 23 °C of adhesive layer (Y2), described later, was the adhesive layer (Y2).

### (2) Measurement of 180° Peeling Force at 23 °C of Adhesive Layer (Y1) for Polytetrafluoroethylene

The adhesive layer (Y1) was pressure-bonded to a 2-mm-thick polytetrafluoroethylene sheet (Yodoflon, available from Yodogawa Hu-Tech Co., Ltd.), and the 180° peeling force at 23 °C of the adhesive layer (Y1) for polytetrafluoroethylene was measured as in Example 1. Tables 4 and 6 show the results.

### (3) Measurement of Heat Shrinkage of Substrate

The heat shrinkage of the substrate was determined as in Example 1. Tables 4 and 6 show the results.

### (4) Measurement of Probe Tack Value at 23 °C of Adhesive Layer (Y2)

In Examples 15 to 18 and 21 to 23, the obtained adhesive sheet was cut into a size of 30 mm in width×30 mm in length to prepare a specimen. A probe tack test was performed on the adhesive layer (Y2) of the prepared specimen using a probe tack tester (TAC-2 available from RHESCA) at 23 °C, a pressuring pressure of 98 gf, a pressuring speed of 100 mm/sec, a pressuring time of 10 seconds, and a withdrawal speed of 5 mm/sec, whereby the probe tack value at 23 °C of the adhesive layer (Y2) was measured. Tables 4 and 6 show the results.

### Examples 19 and 20

A laminate film including an adhesive layer (Y1) with the composition and the thickness shown in Table 4 was prepared as in Examples 15 to 18 and 21 to 23. The laminate film was then placed on the substrate shown in Table 4, whereby an adhesive sheet was obtained that included the substrate and the adhesive layer (Y1) on one surface of the substrate. Subsequently, a laminate film including an adhesive layer (Y2) with the composition and thickness shown in Table 4 was prepared as in Examples 15 to 18 and 21 to 23. The adhesive layer (Y2) was heat-laminated at 100 °C to the other surface of the substrate of the adhesive sheet including the substrate and the adhesive layer (Y1) on one surface of the substrate. Thus, an adhesive sheet was obtained that included the substrate, the adhesive layer (Y1) on one first surface, and the adhesive layer (Y2) on the other surface. The measurements were performed as in Examples 15 to 18 and 21 to 23 and Comparative Examples 8 and 9. Table 4 shows the results.

### <Evaluation>

The adhesive sheets obtained in the examples and the comparative examples were evaluated as follows. Tables 3 to 6 show the results.

### (Adhesion of Adhesive Sheet to Fluororesin)

The adhesion of the adhesive sheet to fluororesin was evaluated based on the 180° peeling force at 23 °C of the adhesive layer (Y1) for polytetrafluoroethylene obtained in (2) Measurement of 180° peeling force of adhesive layer (Y1) for polytetrafluoroethylene described above. The criteria were as follows: a 180° peeling force of 10 N/25 mm or greater was rated as ∘∘; a 180° peeling force of 7 N/25 mm or greater and less than 10 N/25 mm was rated as ∘; a 180° peeling force of 5 N/25 mm or greater and less than 7 N/25 mm was rated as Δ; and a 180° peeling force of less than 5 N/25 mm was rated as x.

### (Peelability of Adhesive Sheet)

The obtained adhesive sheet was cut into a size of 25 mm in width×100 mm in length to prepare a specimen.

A chloroprene adhesive (575F, available from Cemedine Co., Ltd.) was applied to a surface of a 1-mm-thick SUS304 plate (SUS304 plate washed with ethanol and then wiped dry) to a thickness of 100 μm, and dried at 110 °C for 30 minutes to form a chloroprene adhesive layer on the SUS304 plate. A 2-mm-thick polytetrafluoroethylene sheet (Yodoflon, available from Yodogawa Hu-Tech Co., Ltd.) was laminated onto the adhesive layer (Y1) surface of the specimen prepared above. The substrate or the adhesive layer (Y2) of the laminated specimen (the substrate in the case of the one-sided adhesive sheet, the adhesive layer (Y2) in the case of the double-sided adhesive sheet) was then placed on the formed chloroprene adhesive layer. The workpiece was left to stand in an environment of 120 °C for 30 minutes with a load of 2 kg applied thereto, whereby a test sample was prepared.

The 180° peeling force for SUS was measured with the obtained test sample in conformity with JIS Z237 by peeling the adhesive sheet off from the SUS304 plate at 23 °C, a peel rate of 300 mm/min, and a peel angle of 180° using a tensile tester (Tensilon, available from Orientec).

The peelability of the adhesive sheet was evaluated based on the obtained 180° peeling force for SUS. The criteria were as follows: a 180° peeling force of 40 N/25 mm or greater was rated as ∘∘; a 180° peeling force of 20 N/25 mm or greater and less than 40 N/25 mm was rated as ∘; and a 180° peeling force of less than 20 N/25 mm was rated as x. This evaluation was to assess the peeling resistance of the substrate of the adhesive sheet.

TABLE 3

| | | | | Example | | | | | | |
|---|---|---|---|---|---|---|---|---|---|---|
| | | | | 1 | 2 | 3 | 4 | 5 | 6 | 7 |
| Adhesive | Thickness (μm) | | | 50 | 50 | 50 | 100 | 50 | 300 | 500 |
| layer | Base | Acrylic | Type | 1 | 3 | 2 | — | — | 1 | 1 |
| (Y1) | polymer | copolymer | Parts | 100 | 100 | 100 | — | — | 100 | 100 |
| | (P1) | | by mass | | | | | | | |
| | | Styrene | Quintac | — | — | — | 100 | — | — | — |
| | | elastomer | 3421 | | | | | | | |
| | | (parts | (Zeon | | | | | | | |
| | | by mass) | Corporation) | | | | | | | |
| | | Silicone | KR-3700 | — | — | — | — | 100 | — | — |
| | | resin | (Shin-Etsu | | | | | | | |
| | | (parts | Chemical | | | | | | | |
| | | by mass) | Co., Ltd.) | | | | | | | |
| | Tackifier | Type | | A | C | B | B | E | B | A |
| | resin (T1) | Parts by mass | | 10 | 15 | 20 | 10 | 10 | 10 | 10 |
| | Tackifier | Rosin ester resin (softening | | — | — | — | — | — | — | — |
| | resin (T2) | point 100 °C, hydroxy value 40 mg KOH/g) | | | | | | | | |
| | (parts | (Pinecrystal KE-359, Arakawa Chemical Industries Ltd.) | | | | | | | | |
| | by mass) | Terpene resin (softening | | — | — | — | 60 | — | — | — |
| | | point 125 °C, hydroxy value 0 mg KOH/g) | | | | | | | | |
| | | (YS Resin PX1250, Yasuhara Chemical Co., Ltd.) | | | | | | | | |
| | | Terpene phenol resin (softening | | — | — | — | — | — | — | — |
| | | point 150 °C, hydroxy value 120 mg KOH/g) | | | | | | | | |
| | | (YS Polyster G150, Yasuhara Chemical Co., Ltd.) | | | | | | | | |
| | | Petroleum resin (softening | | — | — | — | — | — | — | — |
| | | point 140 °C, hydroxy value 0 mg KOH/g) | | | | | | | | |
| | | (ARKON P-140, Arakawa Chemical Industries Ltd.) | | | | | | | | |
| | Curing | Isocyanate | | 0.5 | 0.5 | 0.5 | — | — | 0.5 | 0.5 |
| | agent | curing agent | | | | | | | | |
| | (parts | (Desmodur L-75, | | | | | | | | |
| | by mass) | available from Covestro) | | | | | | | | |
| | Catalyst | Platinum catalyst (CAT-PL-50T, | | — | — | — | — | 0.5 | — | — |
| | (parts | Shin-Etsu Chemical Co., Ltd.) | | | | | | | | |
| | by mass) | | | | | | | | | |
| Substrate | Thickness (μm) | | | 60 | 1800 | 300 | 1800 | 60 | 1800 | 300 |
| | Type | Non-woven fabric (G2260-1S, | | Pres- | — | — | — | Pres- | — | — |
| | | Toray International, Inc.) | | ent | | | | ent | | |
| | | Glass cloth (KS2770, | | — | — | Pres- | — | — | — | Pres- |
| | | Nitto Boseki Co., Ltd.) | | | | ent | | | | ent |
| | | Carbon cloth (C-540, | | — | Pres- | — | Pres- | — | Pres- | — |
| | | Hagihara Industries Inc.) | | | ent | | ent | | ent | |
| | | Metal mesh (NASLON, | | — | — | — | — | — | — | — |
| | | Nippon Seisen, Co., Ltd.) | | | | | | | | |
| | | Open-cell polyurethane | | — | — | — | — | — | — | — |
| | | foam (PORON, Inoac Corporation) | | | | | | | | |
| | | Biaxially oriented PET film | | — | — | — | — | — | — | — |
| | | (FE2002, Futamura Chemical Co., Ltd.) | | | | | | | | |
| | | Closed-cell PE foam (WL02, | | — | — | — | — | — | — | — |
| | | Sekisui Chemical Co., Ltd.) | | | | | | | | |
| 180° Peeling force at 23 °C of adhesive layer (Y1) for polytetrafluoroethylene | | | | 8.5 | 10.5 | 9.4 | 19.5 | 5.6 | 22.6 | 26.7 |
| (N/25 mm) | | | | | | | | | | |
| Heat shrinkage of substrate (%) | | | | 0.7 | 0.1 | 0.1 | 0.1 | 0.8 | 0.2 | 0.1 |
| Evaluation | Adhesion | Rating | | ∘ | ∘∘ | ∘ | ∘∘ | Δ | ∘∘ | ∘∘ |
| | of | | | | | | | | | |
| | adhesive | | | | | | | | | |
| | sheet to | | | | | | | | | |
| | fluororesin | | | | | | | | | |

| | | | | | | | | |
|---|---|---|---|---|---|---|---|---|
| Peelability | 180° Peeling force | 30.6 | 47.1 | 43.0 | 63.0 | 20.2 | 60.2 | 57.0 |
| of | for SUS (N/25 mm) | | | | | | | |
| adhesive | Rating | ∘ | ∘∘ | ∘∘ | ∘∘ | ∘ | ∘∘ | ∘∘ |
| sheet | | | | | | | | |

| | | | | Example | | | | | | |
|---|---|---|---|---|---|---|---|---|---|---|
| | | | | 8 | 9 | 10 | 11 | 12 | 13 | 14 |
| Adhesive | Thickness (μm) | | | 980 | 200 | 50 | 50 | 50 | 50 | 50 |
| layer | Base | Acrylic | Type | — | — | 3 | 1 | — | 3 | 2 |
| (Y1) | polymer | copolymer | Parts | — | — | 100 | 100 | — | 100 | 100 |
| | (P1) | | by mass | | | | | | | |
| | | Styrene | Quintac | 100 | 100 | — | — | 100 | — | — |
| | | elastomer | 3421 | | | | | | | |
| | | (parts | (Zeon | | | | | | | |
| | | by mass) | Corporation) | | | | | | | |
| | | Silicone | KR-3700 | — | — | — | — | — | — | — |
| | | resin | (Shin-Etsu | | | | | | | |
| | | (parts | Chemical | | | | | | | |
| | | by mass) | Co., Ltd.) | | | | | | | |
| | Tackifier | Type | | B | B | C | A | B | C | B |
| | resin (T1) | Parts by mass | | 10 | 10 | 10 | 10 | 10 | 15 | 20 |
| | Tackifier | Rosin ester resin (softening | | — | — | — | — | — | — | — |
| | resin (T2) | point 100 °C, hydroxy value 40 mg KOH/g) | | | | | | | | |
| | (parts | (Pinecrystal KE-359, Arakawa Chemical Industries Ltd.) | | | | | | | | |
| | by mass) | Terpene resin (softening | | — | 60 | — | — | 60 | — | — |
| | | point 125 °C, hydroxy value 0 mg KOH/g) | | | | | | | | |
| | | (YS Resin PX1250, Yasuhara Chemical Co., Ltd.) | | | | | | | | |
| | | Terpene phenol resin (softening | | 30 | — | — | — | — | — | — |
| | | point 150 °C, hydroxy value 120 mg KOH/g) | | | | | | | | |
| | | (YS Polyster G150, Yasuhara Chemical Co., Ltd.) | | | | | | | | |
| | | Petroleum resin (softening | | 30 | — | — | — | — | — | — |
| | | point 140 °C, hydroxy value 0 mg KOH/g) | | | | | | | | |
| | | (ARKON P-140, Arakawa Chemical Industries Ltd.) | | | | | | | | |
| | Curing | Isocyanate | | — | — | 0.5 | 0.5 | — | 0.5 | 0.5 |
| | agent | curing agent | | | | | | | | |
| | (parts | (Desmodur L-75, | | | | | | | | |
| | by mass) | available from Covestro) | | | | | | | | |
| | Catalyst | Platinum catalyst (CAT-PL-50T, | | — | — | — | — | — | — | — |
| | (parts | Shin-Etsu Chemical Co., Ltd.) | | | | | | | | |
| | by mass) | | | | | | | | | |
| Substrate | Thickness (μm) | | | 1800 | 60 | 300 | 1800 | 300 | 390 | 200 |
| | Type | Non-woven fabric (G2260-1S, | | — | Pres- | — | — | — | — | — |
| | | Toray International, Inc.) | | | ent | | | | | |
| | | Glass cloth (KS2770, | | — | — | Pres- | — | Pres- | — | — |
| | | Nitto Boseki Co., Ltd.) | | | | ent | | ent | | |
| | | Carbon cloth (C-540, | | Pres- | — | — | Pres- | — | — | — |
| | | Hagihara Industries Inc.) | | ent | | | ent | | | |
| | | Metal mesh (NASLON, | | — | — | — | — | — | Pres- | — |
| | | Nippon Seisen, Co., Ltd.) | | | | | | | ent | |
| | | Open-cell polyurethane | | — | — | — | — | — | — | Pres- |
| | | foam (PORON, Inoac Corporation) | | | | | | | | ent |
| | | Biaxially oriented PET film | | — | — | — | — | — | — | — |
| | | (FE2002, Futamura Chemical Co., Ltd.) | | | | | | | | |
| | | Closed-cell PE foam (WL02, | | — | — | — | — | — | — | — |
| | | Sekisui Chemical Co., Ltd.) | | | | | | | | |
| 180° Peeling force at 23 °C of adhesive layer (Y1) for polytetrafluoroethylene | | | | 35.6 | 17.9 | 7.6 | 9.1 | 15.4 | 11.4 | 8.4 |
| (N/25 mm) | | | | | | | | | | |
| Heat shrinkage of substrate (%) | | | | 0.1 | 0.7 | 0.1 | 0.2 | 0.1 | 0.1 | 1.1 |
| Evaluation | Adhesion | Rating | | ∘∘ | ∘∘ | ∘ | ∘ | ∘∘ | ∘∘ | ∘ |
| | of | | | | | | | | | |
| | adhesive | | | | | | | | | |
| | sheet to | | | | | | | | | |
| | fluororesin | | | | | | | | | |

| | | | | | | | | |
|---|---|---|---|---|---|---|---|---|
| Peelability | 180° Peeling force | 72.2 | 37.6 | 25.0 | 37.2 | 50.6 | 56.1 | 21.6 |
| of | for SUS (N/25 mm) | | | | | | | |
| adhesive | Rating | ∘∘ | ∘ | ∘ | ∘ | ∘∘ | ∘∘ | ∘ |
| sheet | | | | | | | | |

TABLE 4

| | | | | Example | | | | |
|---|---|---|---|---|---|---|---|---|
| | | | | 15 | 16 | 17 | 18 | 19 |
| Adhesive | Thickness (μm) | | | 50 | 50 | 50 | 50 | 50 |
| layer | Base polymer | Acrylic | Type | 1 | — | 3 | 2 | — |
| (Y1) | (P1) | copolymer | Parts by mass | 100 | — | 100 | 100 | — |
| | | Styrene elastomer | Quintac 3421 (Zeon Corporation) | — | 100 | — | — | 100 |
| | | (parts by mass) | | | | | | |
| | Tackifier resin | Type | | A | B | C | B | B |
| | (T1) | Parts by mass | | 10 | 10 | 15 | 20 | 10 |
| | Tackifier resin | Rosin ester resin (softening point 100 °C, hydroxy value 40 mg KOH/g) | | — | — | — | — | — |
| | (T2) | (Pinecrystal KE-359, Arakawa Chemical Industries Ltd.) | | | | | | |
| | (parts by mass) | Terpene resin (softening point 125 °C, hydroxy value 0 mg KOH/g) | | — | 60 | — | — | 60 |
| | | (YS Resin PX1250, Yasuhara Chemical Co., Ltd.) | | | | | | |
| | Curing agent | Isocyanate curing agent | | 0.5 | — | 0.5 | 0.5 | — |
| | (parts by mass) | (Coronate L-45, Tosoh Corporation) | | | | | | |
| Substrate | Thickness (μm) | | | 390 | 300 | 390 | 200 | 300 |
| | Type | Glass cloth (KS2770, Nitto Boseki Co., Ltd.) | | — | Present | — | — | Present |
| | | Carbon cloth (C-540, Hagihara Industries Inc.) | | Present | — | — | — | — |
| | | Metal mesh (NASLON, Nippon Seisen, Co., Ltd.) | | — | — | Present | — | — |
| | | Open-cell polyurethane foam (PORON, Inoac Corporation) | | — | — | — | Present | — |
| Adhesive | Thickness (μm) | | | 50 | 50 | 50 | 50 | 50 |
| layer | Base polymer | Acrylic copolymer | Type | 1 | — | 3 | 2 | — |
| (Y2) | (P2) | | Parts by mass | 100 | — | 100 | 100 | — |
| | | Styrene elastomer | Quintac 3421 (Zeon Corporation) | — | 100 | — | — | — |
| | | (parts by mass) | | | | | | |
| | | Chloroprene rubber | 575F (Cemedine Co., Ltd.)) | — | — | — | — | 100 |
| | | (parts by mass) | | | | | | |
| | Tackifier resin | Synthesis Example A | | 10 | — | — | — | — |
| | (T3) | Synthesis Example B | | — | 10 | — | 20 | — |
| | (parts by mass) | Synthesis Example C | | — | — | 15 | — | — |
| | | Rosin ester resin (softening point 100 °C, hydroxy value 40 mg KOH/g) | | — | — | — | — | — |
| | | (Pinecrystal KE-359, Arakawa Chemical Industries Ltd.) | | | | | | |
| | | Terpene resin (softening point 125 °C, hydroxy value 0 mg KOH/g) | | — | 60 | — | — | — |
| | | (YS Resin PX1250, Yasuhara Chemical Co., Ltd.) | | | | | | |
| | Curing agent | Isocyanate curing agent | | 0.5 | — | 0.5 | 0.5 | — |
| | (parts by mass) | (Desmodur L-75, available from Covestro) | | | | | | |
| 180° Peeling force at 23 °C of adhesive layer (Y1) for polytetrafluoroethylene | | | | 13.4 | 23.5 | 16.4 | 13.5 | 23.5 |
| (N/25 mm) | | | | | | | | |
| Heat shrinkage of substrate (%) | | | | 0.1 | 0.1 | 0.1 | 1.4 | 0.1 |
| Probe tack value at 23 °C of adhesive layer (Y2) (gf/5 mmφ) | | | | 2356 | 2501 | 2011 | 2104 | 120 |
| Evaluation | Adhesion of | Rating | | ∘∘ | ∘∘ | ∘∘ | ∘∘ | ∘∘ |
| | adhesive sheet to | | | | | | | |
| | fluororesin | | | | | | | |

| | | | | | | |
|---|---|---|---|---|---|---|
| Peelability of | 180° Peeling force for SUS (N/25 mm) | 46.6 | 57.4 | 60.1 | 34.1 | 57.4 |
| adhesive sheet | Rating | ∘∘ | ∘∘ | ∘∘ | ∘ | ∘∘ |

| | | | | Example | | | |
|---|---|---|---|---|---|---|---|
| | | | | 20 | 21 | 22 | 23 |
| Adhesive | Thickness (μm) | | | 500 | 300 | 980 | 24 |
| layer | Base polymer | Acrylic | Type | 1 | 1 | — | 1 |
| (Y1) | (P1) | copolymer | Parts by mass | 100 | 100 | — | 100 |
| | | Styrene elastomer | Quintac 3421 (Zeon Corporation) | — | — | 100 | — |
| | | (parts by mass) | | | | | |
| | Tackifier resin | Type | | A | B | B | A |
| | (T1) | Parts by mass | | 10 | 10 | 10 | 10 |
| | Tackifier resin | Rosin ester resin (softening point 100 °C, hydroxy value 40 mg KOH/g) | | — | — | — | 10 |
| | (T2) | (Pinecrystal KE-359, Arakawa Chemical Industries Ltd.) | | | | | |
| | (parts by mass) | Terpene resin (softening point 125 °C, hydroxy value 0 mg KOH/g) | | — | — | — | — |
| | | (YS Resin PX1250, Yasuhara Chemical Co., Ltd.) | | | | | |
| | Curing agent | Isocyanate curing agent | | 0.5 | 2.0 | — | — |
| | (parts by mass) | (Coronate L-45, Tosoh Corporation) | | | | | |
| Substrate | Thickness (μm) | | | 300 | 300 | 300 | 300 |
| | Type | Glass cloth (KS2770, Nitto Boseki Co., Ltd.) | | Present | Present | Present | Present |
| | | Carbon cloth (C-540, Hagihara Industries Inc.) | | — | — | — | — |
| | | Metal mesh (NASLON, Nippon Seisen, Co., Ltd.) | | — | — | — | — |
| | | Open-cell polyurethane foam (PORON, Inoac Corporation) | | — | — | — | — |
| Adhesive | Thickness (μm) | | | 500 | 950 | 300 | 300 |
| layer | Base polymer | Acrylic copolymer | Type | — | 1 | 2 | 2 |
| (Y2) | (P2) | | Parts by mass | — | 100 | 100 | 100 |
| | | Styrene elastomer | Quintac 3421 (Zeon Corporation) | — | — | — | — |
| | | (parts by mass) | | | | | |
| | | Chloroprene rubber | 575F (Cemedine Co., Ltd.)) | 100 | — | — | — |
| | | (parts by mass) | | | | | |

| | Tackifier resin | Synthesis Example A | — | 10 | — | — |
|---|---|---|---|---|---|---|
| | (T3) | Synthesis Example B | — | — | 10 | 10 |
| | (parts by mass) | Synthesis Example C | — | — | — | — |
| | | Rosin ester resin (softening point 100 °C, hydroxy value 40 mg KOH/g) | — | — | 20 | 20 |
| | | (Pinecrystal KE-359, Arakawa Chemical Industries Ltd.) | | | | |
| | | Terpene resin (softening point 125 °C, hydroxy value 0 mg KOH/g) | — | — | 30 | 30 |
| | | (YS Resin PX1250, Yasuhara Chemical Co., Ltd.) | | | | |
| | Curing agent | Isocyanate curing agent | — | 0.5 | 1.0 | 1.0 |
| | (parts by mass) | (Desmodur L-75, available from Covestro) | | | | |
| 180° Peeling force at 23 °C of adhesive layer (Y1) for polytetrafluoroethylene | | | 26.4 | 23.1 | 38.1 | 5.3 |
| (N/25 mm) | | | | | | |
| Heat shrinkage of substrate (%) | | | 0.1 | 0.1 | 0.1 | 0.1 |
| Probe tack value at 23 °C of adhesive layer (Y2) (gf/5 mmφ) | | | 142 | 2415 | 651 | 612 |
| Evaluation | Adhesion of | Rating | ∘∘ | ∘∘ | ∘∘ | Δ |

adhesive sheet to
fluororesin

| | | | | | |
|---|---|---|---|---|---|
| Peelability of | 180° Peeling force for SUS (N/25 mm) | 115.1 | 192.1 | 81.4 | 46.7 |
| adhesive sheet | Rating | ∘∘ | ∘∘ | ∘∘ | ∘∘ |

TABLE 5

| | | | | Comparative Example | | | |
|---|---|---|---|---|---|---|---|
| | | | | 1 | 2 | 3 | 4 |
| Adhesive | Thickness (μm) | | | 50 | 50 | 50 | 50 |
| layer | Base polymer | Acrylic copolymer | Type | 1 | 3 | — | 3 |
| (Y1) | (P1) | | Parts by mass | 100 | 100 | — | 100 |
| | | Styrene elastomer | Quintac 3421 (Zeon Corporation) | — | — | 100 | — |
| | | (parts by mass) | | | | | |
| | | Silicone resin | KR-3700 (Shin-Etsu Chemical Co., Ltd.) | — | — | — | — |
| | | (parts by mass) | | | | | |
| | Tackifier resin | Type | | A | C | C | — |
| | (T1) | Parts by mass | | 10 | 15 | 15 | — |
| | Tackifier resin | Rosin ester resin (softening point 100 °C, hydroxy value 40 mg KOH/g) | | — | — | — | — |
| | (T2) | (Pinecrystal KE-359, Arakawa Chemical Industries Ltd.) | | | | | |
| | (parts by mass) | Terpene resin (softening point 125 °C, hydroxy value 0 mg KOH/g) | | — | — | 30 | — |
| | | (YS Resin PX1250, Yasuhara Chemical Co., Ltd.) | | | | | |
| | | Terpene phenol resin (softening point 150 °C, hydroxy value 120 mg KOH/g) | | — | — | — | — |
| | | (YS Polyster G150, Yasuhara Chemical Co., Ltd.) | | | | | |
| | | Petroleum resin (softening point 140 °C, hydroxy value 0 mg KOH/g) | | — | — | 40 | — |
| | | (ARKON P-140, Arakawa Chemical Industries Ltd.) | | | | | |
| | Curing agent | Isocyanate curing agent | | 0.5 | 0.5 | — | 0.5 |
| | (parts by mass) | (Desmodur L-75, available from Covestro) | | | | | |
| | Catalyst | Platinum catalyst (CAT-PL-50T, Shin-Etsu Chemical Co., Ltd.) | | — | — | — | — |
| | (parts by mass) | | | | | | |
| Substrate | Thickness (μm) | | | 23 | 23 | 200 | 300 |
| | Type | Non-woven fabric (G2260-1S, Toray International, Inc.) | | — | — | — | — |
| | | Glass cloth (KS2770, Nitto Boseki Co., Ltd.) | | — | — | — | Present |
| | | Carbon cloth (C-540, Hagihara Industries Inc.) | | — | — | — | — |
| | | Metal mesh (NASLON, Nippon Seisen, Co., Ltd.) | | — | — | — | — |
| | | Open-cell polyurethane foam (PORON, Inoac Corporation) | | — | — | — | — |
| | | Biaxially oriented PET film (FE2002, Futamura Chemical Co., Ltd.) | | Present | Present | — | — |
| | | Closed-cell PE foam (WL02, Sekisui Chemical Co., Ltd.) | | — | — | Present | — |
| 180° Peeling force at 23 °C of adhesive layer (Y1) for polytetrafluoroethylene | | | | 8.4 | 9.8 | 14.5 | 3.4 |
| (N/25 mm) | | | | | | | |
| Heat shrinkage of substrate (%) | | | | 1.6 | 1.5 | 4.6 | 0.1 |
| Evaluation | Adhesion of | Rating | | ∘ | ∘ | ∘∘ | x |
| | adhesive sheet to | | | | | | |
| | fluororesin | | | | | | |

| | | | | | |
|---|---|---|---|---|---|
| Peelability of | 180° Peeling force for SUS (N/25 mm) | 15.6 | 19.5 | 18.8 | 9.0 |
| adhesive sheet | Rating | x | x | x | x |

| | | | | Comparative Example | | |
|---|---|---|---|---|---|---|
| | | | | 5 | 6 | 7 |
| Adhesive | Thickness (μm) | | | 50 | 20 | 10 |
| layer | Base polymer | Acrylic copolymer | Type | 2 | 1 | 2 |
| (Y1) | (P1) | | Parts by mass | 100 | 100 | 100 |
| | | Styrene elastomer | Quintac 3421 (Zeon Corporation) | — | — | — |
| | | (parts by mass) | | | | |
| | | Silicone resin | KR-3700 (Shin-Etsu Chemical Co., Ltd.) | — | — | — |
| | | (parts by mass) | | | | |

| Tackifier resin | Type | — | A | B |
|---|---|---|---|---|
| (T1) | Parts by mass | — | 10 | 10 |
| Tackifier resin | Rosin ester resin (softening point 100 °C, hydroxy value 40 mg KOH/g) | — | — | 20 |
| (T2) | (Pinecrystal KE-359, Arakawa Chemical Industries Ltd.) | | | |
| (parts by mass) | Terpene resin (softening point 125 °C, hydroxy value 0 mg KOH/g) | — | — | 10 |
| | (YS Resin PX1250, Yasuhara Chemical Co., Ltd.) | | | |
| | Terpene phenol resin (softening point 150 °C, hydroxy value 120 mg KOH/g) | — | — | — |
| | (YS Polyster G150, Yasuhara Chemical Co., Ltd.) | | | |
| | Petroleum resin (softening point 140 °C, hydroxy value 0 mg KOH/g) | — | — | — |
| | (ARKON P-140, Arakawa Chemical Industries Ltd.) | | | |
| Curing agent | Isocyanate curing agent | 0.5 | 0.5 | 0.5 |
| (parts by mass) | (Desmodur L-75, available from Covestro) | | | |
| Catalyst | Platinum catalyst (CAT-PL-50T, Shin-Etsu Chemical Co., Ltd.) | — | — | — |
| (parts by mass) | | | | |

| Substrate | Thickness (μm) | | 1800 | 300 | 60 |
|---|---|---|---|---|---|
| | Type | Non-woven fabric (G2260-1S, Toray International, Inc.) | — | — | Present |
| | | Glass cloth (KS2770, Nitto Boseki Co., Ltd.) | — | Present | — |
| | | Carbon cloth (C-540, Hagihara Industries Inc.) | Present | — | — |
| | | Metal mesh (NASLON, Nippon Seisen, Co., Ltd.) | — | — | — |
| | | Open-cell polyurethane foam (PORON, Inoac Corporation) | — | — | — |
| | | Biaxially oriented PET film (FE2002, Futamura Chemical Co., Ltd.) | — | — | — |
| | | Closed-cell PE foam (WL02, Sekisui Chemical Co., Ltd.) | — | — | — |
| 180° Peeling force at 23 °C of adhesive layer (Y1) for polytetrafluoroethylene | | | 3.5 | 4.3 | 2.5 |
| (N/25 mm) | | | | | |
| Heat shrinkage of substrate (%) | | | 0.1 | 0.2 | 0.7 |
| Evaluation | Adhesion of | Rating | x | x | x |

adhesive sheet to
fluororesin

| | | | | |
|---|---|---|---|---|
| Peelability of | 180° Peeling force for SUS (N/25 mm) | 15.2 | 17.8 | 4.2 |
| adhesive sheet | Rating | x | x | x |

TABLE 6

| | | | | Comparative Example | |
|---|---|---|---|---|---|
| | | | | 8 | 9 |
| Adhesive | Thickness (μm) | | | 50 | 50 |
| layer | Base polymer | Acrylic copolymer | Type | 1 | — |
| (Y1) | (P1) | | Parts by mass | 100 | — |
| | | Styrene elastomer | Quintac 3421 (Zeon Corporation) | — | 100 |
| | | (parts by mass) | | | |
| | Tackifier resin | Type | | B | C |
| | (T1) | Parts by mass | | 10 | 15 |
| | Tackifier resin | Rosin ester resin (softening point 100 °C, hydroxy value 40 mg KOH/g) | | — | — |
| | (T2) | (Pinecrystal KE-359, Arakawa Chemical Industries Ltd.) | | | |
| | (parts by mass) | Terpene resin (softening point 125 °C, hydroxy value 0 mg KOH/g) | | — | 30 |
| | | (YS Resin PX1250, Yasuhara Chemical Co., Ltd.) | | | |
| | | Terpene phenol resin (softening point 150 °C, hydroxy value 120 mg KOH/g) | | — | — |
| | | (YS Polyster G150, Yasuhara Chemical Co., Ltd.) | | | |
| | | Petroleum resin (softening point 140 °C, hydroxy value 0 mg KOH/g) | | — | 40 |
| | | (ARKON P-140, Arakawa Chemical Industries Ltd.) | | | |
| | Curing agent | Isocyanate curing agent | | 0.5 | — |
| | (parts by mass) | (Coronate L-45, Tosoh Corporation) | | | |
| Substrate | Thickness (μm) | | | 23 | 200 |
| | Type | Glass cloth (KS2770, Nitto Boseki Co., Ltd.) | | — | — |
| | | Carbon cloth (C-540, Hagihara Industries Inc.) | | — | — |
| | | Metal mesh (NASLON, Nippon Seisen, Co., Ltd.) | | — | — |
| | | Open-cell polyurethane foam (PORON, Inoac Corporation) | | — | — |
| | | Biaxially oriented PET film (FE2002, Futamura Chemical Co., Ltd.) | | Present | — |
| | | Closed-cell PE foam (WL02, Sekisui Chemical Co., Ltd.) | | — | Present |
| Adhesive | Thickness (μm) | | | 50 | 50 |
| layer | Base polymer | Acrylic copolymer | Type | 1 | — |
| (Y2) | (P2) | | Parts by mass | 100 | — |
| | | Styrene elastomer | Quintac 3421 (Zeon Corporation) | — | 100 |
| | | (parts by mass) | | | |

| | Tackifier resin | Synthesis Example B | 10 | — |
|---|---|---|---|---|
| | (T3) | Synthesis Example C | — | 15 |
| | (parts by mass) | Rosin ester resin (softening point 100 °C, hydroxy value 40 mg KOH/g) | — | — |
| | | (Pinecrystal KE-359, Arakawa Chemical Industries Ltd.) | | |
| | | Terpene resin (softening point 125 °C, hydroxy value 0 mg KOH/g) | — | 30 |
| | | (YS Resin PX1250, Yasuhara Chemical Co., Ltd.) | | |
| | | Terpene phenol resin (softening point 150 °C, hydroxy value 120 mg KOH/g) | — | — |
| | | (YS Polyster G150, Yasuhara Chemical Co., Ltd.) | | |
| | | Petroleum resin (softening point 140 °C, hydroxy value 0 mg KOH/g) | — | 40 |
| | | (ARKON P-140, Arakawa Chemical Industries Ltd.) | | |
| | Curing agent | Isocyanate curing agent | 0.5 | — |
| | (parts by mass) | (Desmodur L-75, available from Covestro) | | |
| 180° Peeling force at 23 °C of adhesive layer (Y1) for polytetrafluoroethylene | | | 9.2 | 13.5 |
| (N/25 mm) | | | | |
| Heat shrinkage of substrate (%) | | | 1.7 | 5.3 |
| Evaluation | Adhesion of | Rating | ○ | ○○ |
| | adhesive sheet to | | | |
| | fluororesin | | | |
| | Peelability of | 180° Peeling force for SUS (N/25 mm) | 17.6 | 19.1 |
| | adhesive sheet | Rating | x | x |

### INDUSTRIAL APPLICABILITY

The present invention can provide an adhesive sheet that, on one surface, has excellent adhesion to fluororesins such as polytetrafluoroethylene without requiring any pretreatment on the fluororesin and, on the other surface, is capable of suppressing peeling of the substrate. The present invention can also provide a laminate sheet including the adhesive sheet. The present invention can also enable production of a chemical tank to which the adhesive sheet or the laminate sheet is attached. The present invention can also provide a method for producing a chemical tank using the laminate sheet or the adhesive sheet.

1. An adhesive sheet comprising:
a substrate; and
an adhesive layer (Y1) on one surface of the substrate,
the substrate including at least one selected from the group consisting of a non-woven fabric, a glass cloth, a carbon cloth, a metal mesh, and a foam having an open-cell structure,
the adhesive sheet having a 180° peeling force at 23 °C for polytetrafluoroethylene of 5.0 N/25 mm or greater on an adhesive layer (Y1) side of the adhesive sheet.

2. The adhesive sheet according to claim 1, further comprising an adhesive layer (Y2) on another surface of the substrate.

3. The adhesive sheet according to claim 1,
wherein the adhesive layer (Y1) contains a base polymer (P1) and a tackifier resin, and
the base polymer (P1) includes at least one selected from the group consisting of a (meth)acrylic copolymer, a styrene elastomer, and a silicone resin.

4. The adhesive sheet according to claim 3,
wherein the tackifier resin includes a tackifier resin (T1) that contains at least one structural unit (A) selected from the group consisting of a structural unit (A-1), a structural unit (A-1′), a structural unit (A-2), a structural unit (A-2′), a structural unit (A-3), a structural unit (A-3′), a structural unit (A-4), and a structural unit (A-4′) that are represented by the following formulas: 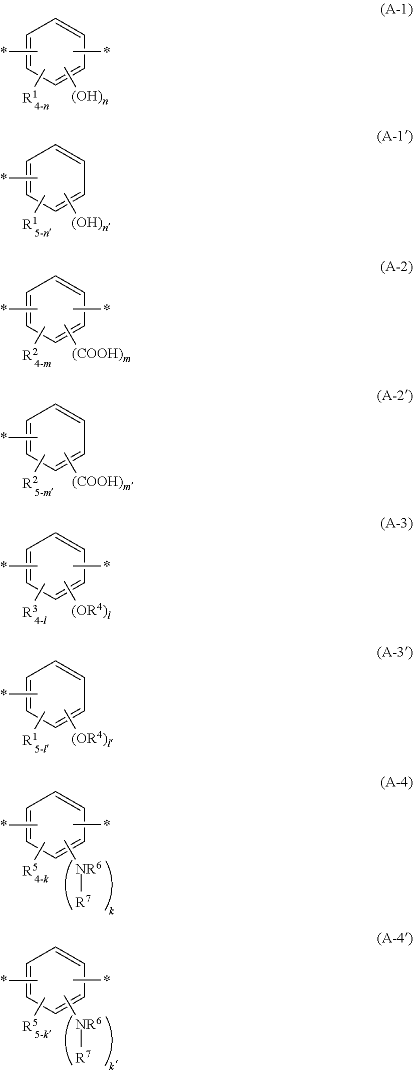
wherein R¹ to R⁷ each represent a hydrogen atom, an aliphatic hydrocarbon group, an aromatic hydrocarbon group, a polar functional group, an aliphatic hydrocarbon group containing a polar functional group, or an aromatic hydrocarbon group containing a polar functional group; n and 1 each represent an integer of 2 or greater and 4 or less; n′ and l′ each represent an integer of 2 or greater and 5 or less; m and k each represent an integer of 1 or greater and 4 or less; m′ and k′ each represent an integer of 1 or greater and 5 or less; and * represents a linking moiety.

5. The adhesive sheet according to claim 4,
wherein the tackifier resin (T1) further contains a structural unit (B) derived from at least one monomer (b) selected from the group consisting of a terpene monomer and a vinyl monomer.

6. The adhesive sheet according to claim 3,
wherein the tackifier resin includes at least one tackifier resin (T2) selected from the group consisting of a rosin ester resin, a terpene resin, a terpene phenol resin, and a petroleum resin.

7. The adhesive sheet according to claim 1,
wherein the adhesive layer (Y1) has a thickness of 25 μm or greater and 1,000 μm or less.

8. The adhesive sheet according to claim 2,
wherein the adhesive sheet has a probe tack value of 2,000 gf/5 mmφ or less on an adhesive layer (Y2) side of the adhesive sheet as measured at 23 °C, a pressuring pressure of 98 gf, a pressuring speed of 100 mm/sec, a pressuring time of 10 seconds, and a withdrawal speed of 5 mm/sec.

9. The adhesive sheet according to claim 2,
wherein the adhesive layer (Y2) has a thickness of 20 μm or greater and 1,000 μm or less.

10. The adhesive sheet according to claim 1, which is used for lining a tank body of a chemical tank for a semiconductor or of a chemical tank for a chemical industry.

11. A laminate sheet comprising:
the adhesive sheet according to claim 1; and
a fluororesin-containing sheet on a surface of the adhesive layer (Y1), the surface being different from a surface in contact with the substrate.

12. The laminate sheet according to claim 11, which is used for protecting an adherend.

13. The laminate sheet according to claim 12, which is used for protecting an adherend from a chemical liquid.

14. A chemical tank comprising:
a tank body; and
the adhesive sheet according to claim 1, attached to an inner surface of the tank body.

15. A method for producing a chemical tank for a semiconductor or a chemical tank for a chemical industry, the method comprising
a step of attaching the laminate sheet according to claim 11 to an inner surface of a tank body of a chemical tank.

16. A method for producing a chemical tank for a semiconductor or a chemical tank for a chemical industry, the method comprising:
a step of producing a laminate sheet by pressure-bonding a fluororesin-containing sheet to the adhesive layer (Y1) of the adhesive sheet according to claim 2; and
a step of attaching the adhesive layer (Y2) of the laminate sheet to an inner surface of a tank body of a chemical tank.

17. A chemical tank comprising:
a tank body; and
the laminate sheet according to claim 11, attached to an inner surface of the tank body.
